(19) United States
(12) Patent Application Publication
(10) Pub. No.: US 2015/0170277 A1
(43) Pub. Date: Jun. 18, 2015

(54) MUNICIPAL BOND EXCHANGE

(71) Applicants: John V. Repsholdt, Lisle, IL (US); Robert L. Wingader, Evanston, IL (US); Thomas A. Wingader, Evanston, IL (US); Tom Dugovic, Naperville, IL (US)

(72) Inventors: John V. Repsholdt, Lisle, IL (US); Robert L. Wingader, Evanston, IL (US); Thomas A. Wingader, Evanston, IL (US); Tom Dugovic, Naperville, IL (US)

(21) Appl. No.: 14/567,654

(22) Filed: Dec. 11, 2014

Related U.S. Application Data
(60) Provisional application No. 61/916,709, filed on Dec. 16, 2013.

(51) Int. Cl. G06Q 40/04

(52) U.S. Cl. CPC G06Q 40/04

(57) ABSTRACT

An exchange system for municipal bonds and other securities, that comprises a database and a central server coupled to user devices through a network. Bond information is inputted through the user devices, received and processed by the central server, and stored in the database. The exchange system is configured to enable users to input a bid (or offer) based on a bond pool, and processes the transaction against an aggregate of standing offers (or bids) in the system. In addition, the exchange system permits offering of new issues, enables the issue and subscription of MuniSLGs, and identifies and enables the execution of potential tax swaps.

### BACKGROUND OF THE INVENTION

Municipal bonds are a specific type of bond issued by local governments that provide a number of characteristics that distinguish such bonds from standard corporate bonds. For example, interest generated on municipal bonds is typically exempt from federal and State income tax, and new issues often have serial rather than term maturities with call provisions that enable the issuer to retire bonds early. Municipal bonds may also involve different types of risks that affect the value of the bonds. These and other unique characteristics make them more complicated to value compared to corporate bonds and other securities.

The current market for municipal bonds, with its lack of publicly accessible formative pre-trade price information, creates inefficient transactions. Without a central exchange, municipal bond transactions are commonly performed by investors and issuers who lack the necessary information to properly price and characterize the municipal bonds. For example, individual non-institutional investors are usually unaware of the price and yield for the same or equivalent bonds based upon other recent transactions. Such investors often are unaware of alternative bonds that may be economically equivalent and would otherwise be available to purchase. These inefficiencies increase the cost of bond valuation such that an issuer accessing the market with a new issue or an investor buying or selling municipal bonds may not be entering into a fairly-priced transaction.

Although interest paid on municipal bonds is typically exempt from federal income tax, taxable gains may be realized at bond maturity or when a municipal bond is sold at a price that is above its amortized tax basis. Bond owners may also realize losses through the sale of bonds. Similar to corporate bonds, such losses may generally be used to offset capital gains or ordinary income, or may be carried forward to offset future income. Today, managing a municipal bond portfolio to avoid taxable gains and take the most advantageous position regarding realized losses is expensive because of the inefficient market environment.

In addition, the lack of publicly accessible formative pre-trade price information in today's market creates a further problem regarding inefficient pricing. Without a clear view of the market, it is difficult to determine a market-appropriate price for securities.

Accordingly, there exists a need for a comprehensive venue for the exchange of municipal bonds. Ideally, the exchange system will be provided through a computer network, such as, for example, the Internet.

### SUMMARY OF THE INVENTION

Embodiments of the present invention are directed to an exchange system for municipal bonds. In one embodiment, the exchange system comprises a database, which is coupled with a central server configured to execute software processes which allow a user to input municipal bond information and user information, view and sort available municipal bond information of other market participants, and execute trades matched through the exchange system. One or more client or user devices are coupled to the central server through a network for displaying information from the database and inputting or modifying information within the database and system. The database stores the municipal bond information, user information, and other information referenced in the systems and methods discussed herein. For example, the database may store municipal bond information, a snapshot of SLGS interest rates from the United States Treasury Department, and other information. The system may also include a financial institution server and/or a clearing house server. The financial institution server maintains and provides access to information regarding the user's securities and funds that are managed by the financial institution, such as municipal bond portfolios and/or bank account information. In addition, the financial institution server receives and processes queries from the central server relating to the user's transactions on the exchange system, such as the purchase and sale of municipal bonds. The user devices may also directly access the financial institution server to provide account information, effectuate transactions through the exchange system, and conduct other transactions with the financial institution.

### BRIEF DESCRIPTION OF THE DRAWINGS

FIG. 1 is a flowchart of a method to initialize a user and bond portfolio within an exchange system.

FIG. 2A is a flowchart of a method to purchase municipal bonds within an exchange system.

FIG. 2B(i) is a flowchart of a method to sell municipal bonds within an exchange system by merely accepting a bid.

FIG. 2B(ii) is a flowchart of a method to offer to sell municipal bonds within an exchange system.

FIG. 2B(iii) is a flowchart of a method to offer a new issue of municipal bonds within an exchange system.

FIG. 3A is a flowchart of a method to subscribe for MuniSLGs within an exchange system.

FIG. 3B(i) is a flowchart of a method to sell MuniSLGs within an exchange system.

FIG. 3B(ii) is a flowchart of a method to issue new MuniSLGs within an exchange system.

FIG. 4 is a flowchart of a method to perform tax swaps within an exchange system.

FIG. 5A is a system architecture diagram of an exchange system.

FIG. 5B is a logical topology diagram of a system for an exchange system.

FIG. 6 illustrates a graphical user interface of an exchange system according to the embodiment of FIG. 1.

FIG. 7 illustrates a graphical user interface of an exchange system according to the embodiment of FIG. 2A.

FIG. 8 illustrates a further example of a graphical user interface of an exchange system according to the embodiment of FIG. 2A.

FIG. 9 illustrates a further example of a graphical user interface of an exchange system according to the embodiment of FIG. 1.

FIGS. 10A to 10I illustrate examples of graphical user interfaces of an exchange system according to the embodiment of FIG. 4.

### DETAILED DESCRIPTION OF THE INVENTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

An exchange system is described and shown herein, that provides a platform for users to place bids for purchase and/or offers to sell securities, and to engage in other transactions relating to those securities. Although the embodiments described herein are directed to an exchange system for municipal bonds, those of skill in the art will appreciate that the system may also be applied to other types of securities and financial instruments that are known in the art.

As used herein, a municipal bond is, without limitation, a bond issued by a State or local governmental unit or its agencies that generally pays interest that is exempt from federal and State income taxes. Municipal bonds may include, but are not limited to, general obligation bonds, revenue bonds, and/or assessment bonds. Municipal bonds may also be referred to herein as municipal securities. Municipal bonds may refer to a bond within the scope of Section 103(a) of the Internal Revenue Code of 1986, as amended.

A MuniSLG is a type of municipal bond that is similar to a State and Local Government Series security except that the obligor is a State or other significant municipal issuer rather than the United States Treasury Department. In addition, MuniSLGs may be purchased and sold on an exchange system outside of the SLGSafe platform maintained by the United States Treasury Department.

In one embodiment, the exchange system comprises a non-transitory computer readable medium, a microprocessor and a display. The computer readable medium is configured to store information relating to municipal bonds in one or more fields. The microprocessor is coupled to the computer readable medium, and may be programmed with instructions for receiving the municipal bond information, storing it in the computer readable medium, and/or manipulating the information. The display screen is coupled to the microprocessor for displaying information from the computer readable medium, and to enable a user of the exchange system to input, review, select, and modify information within the system.

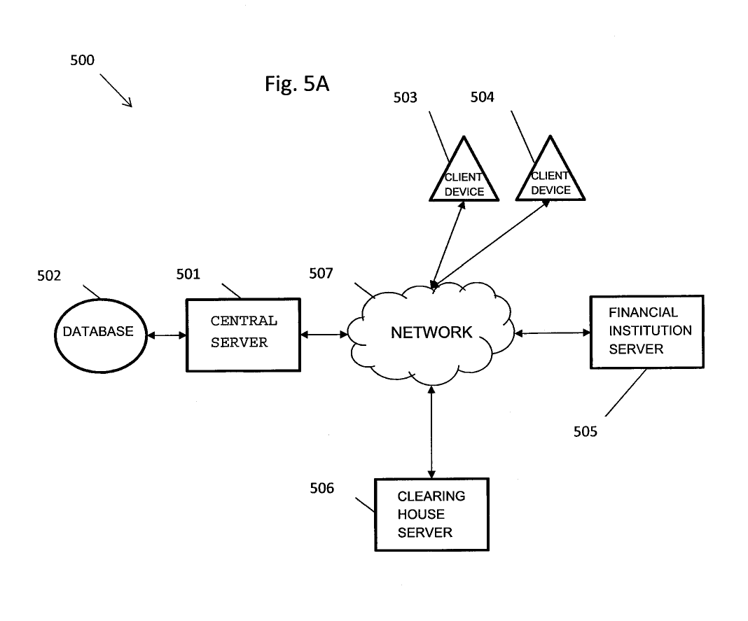

In one embodiment, the exchange system has a system architecture 500 as generally shown in FIG. 5A. The non-transitory computer readable medium comprises a database 502, which is coupled with a central server 501. One or more client or user devices 503, 504 are coupled to the central server 501 through a network 507, for displaying information from the database 502 and inputting or modifying information within the database and system 500.

The database 502 is electronically coupled to the central server 501 by one of various means known in the art, such as through a computer network. The database 502 stores the municipal bond information, user information, and other information referenced in the systems and methods discussed herein. For example, the database may store municipal bond information, a snapshot of SLGS interest rates from the United States Treasury Department, and other information.

The central server 501 may comprise a single server, a plurality of servers, a set of disparate servers providing software as a server through a website, or other configurations known in the art.

The network 507 may be any of the various networks known in the art, including a local intranet, WAN, LAN, token ring network, the Internet, a cellular network, or other routable or non-routable network, or combinations thereof.

The user devices 503, 504 may be any device that is capable of connecting to, accessing and displaying information over the computer network 507, including a cell phone, smartphone, laptop, desktop, tablet, smart television, or other computing device known in the art.

In a further embodiment, the system 500 may also include a financial institution server 505 and/or a clearing house server 506. The financial institution server 505 maintains and provides access to information regarding the user's securities and funds that are managed by the financial institution, such as municipal bond portfolios and/or financial institution account information. In addition, the financial institution server 505 receives and processes queries from the central server 501 relating to the user's transactions on the exchange system 500, such as the purchase and sale of municipal bonds. It should be appreciated that the user devices 503, 504 may also directly access the financial institution server 505 to provide account information, effectuate transactions through the exchange system, and conduct other transactions with the financial institution as are known in the art. Although only a single financial institution server 505 is shown in FIG. 5A, the system 500 may comprise any number of financial institution servers 505 that are required to accommodate the various users of the system and facilitate transactions within the exchange system. For example, where database 502 contains information regarding municipal bonds or funds that are held by a particular financial institution, system 500 may include a financial institution server 505 associated with that financial institution to effectuate transactions relating to those bonds or funds.

As discussed herein, the clearing house server 506 communicates with the financial institution server 505 and the central server 501 to verify the purchase and sale of municipal bonds within the exchange system. Although only one clearing house server 506 is shown in FIG. 5A, it should be appreciated that the system 500 may comprise multiple clearing house servers.

The logical topology 550 of an exchange system in accordance with the system architecture 500 is shown in FIG. 5B. The logical topology 550 includes a central server 551, a buyer's financial institution server 552, a buyer device 553, bidder devices 554, 555, a seller's financial institution server 556, a seller device 557, offer devices 558, 559, and clearing house server 560. It should be appreciated that FIG. 5B expands upon the system 500 in FIG. 5A to show how the exchange system may grow as additional bidder devices 554, 555, offer devices 558, 559, buyer's financial institution server 552, seller's financial institution server 556, and potential additional devices access the system. Although the logical topology 550 does not show a computer network, it is assumed the each component communicates via a computer network.

As shown in FIG. 5B, the central server 551 is configured to mediate the exchange of information between bond seller and owner devices 557, 558, 559 and bond buyer and bidder devices 553, 554, 555. When a transaction is entered between buyer device 553 and seller device 557, the central server 501 communicates with the buyer's financial institution server 552 and seller's financial institution server 556 to effectuate the transfer of securities and/or funds. In addition, both financial institution servers 552 and 556 communicate with the clearing house server 560 to verify the transaction prior to exchanging funds or securities.

In yet another embodiment, the exchange system includes software processes for execution by the microprocessor (or central server). These software processes may be stored on the non-transitory computer readable medium and configured to allow a user to input information to the exchange system, such as municipal bond issuers, interest, yield, and other information. This detailed description is presented in terms of programs, data structures or procedures executed on a computer or network of computers. The software programs implemented by the system may be written in languages such as Java, HTML, Python, C++, C#, or the ASP.Net programming language. However, one of skill in the art will appreciate that other languages may be used instead of, or in combination with, the foregoing.

In a preferred embodiment, the exchange system may operate as software as a service over the Internet, and is accessible from a web browser and/or mobile applications. The exchange system may also provide application programming interfaces which enable the manipulation of data within the system as web services. In an alternative embodiment, the exchange system may comprise server-side software accessible via a private network, such as, for example, within a corporate intranet. In yet another embodiment, the exchange system may operate as locally installed software within a computing device.

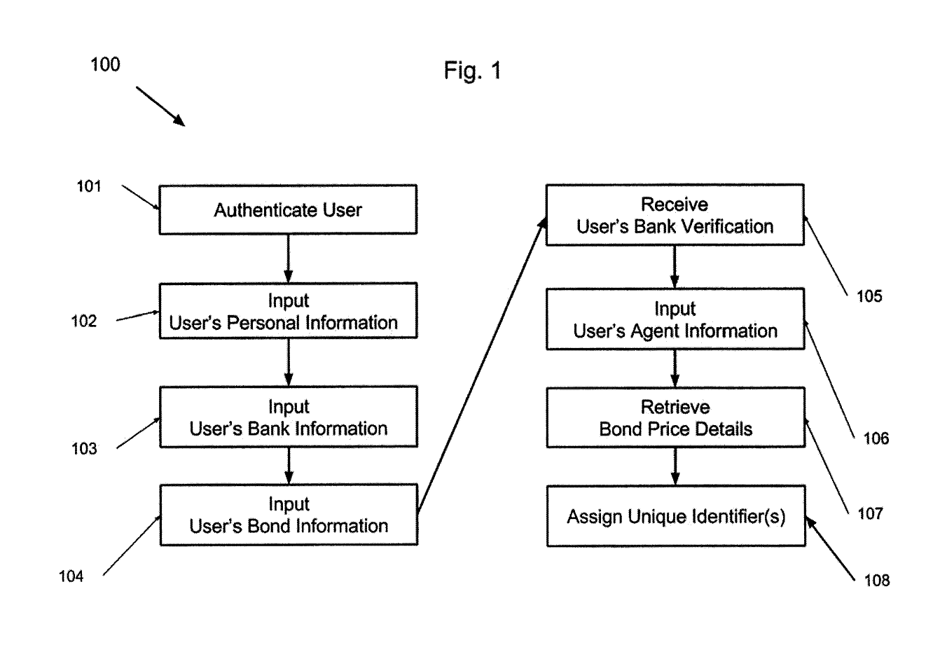

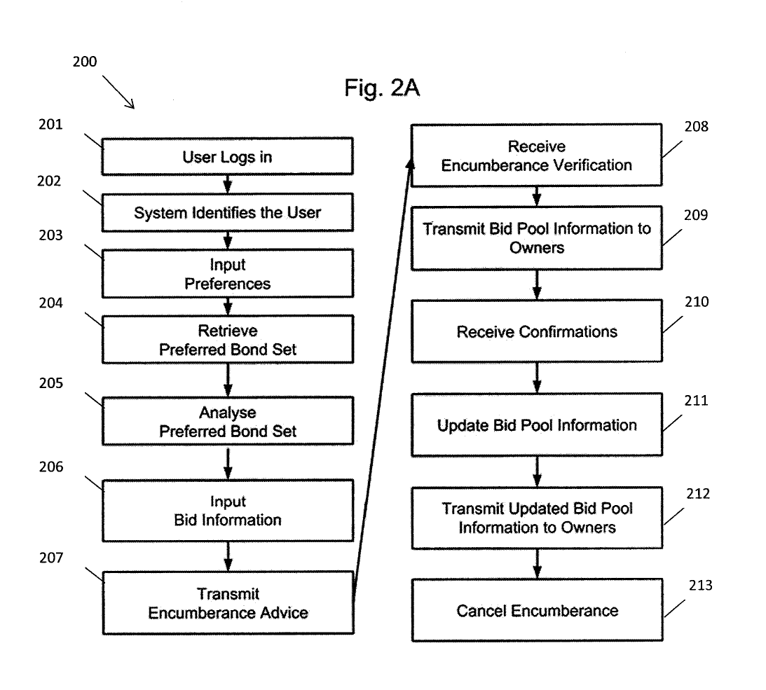

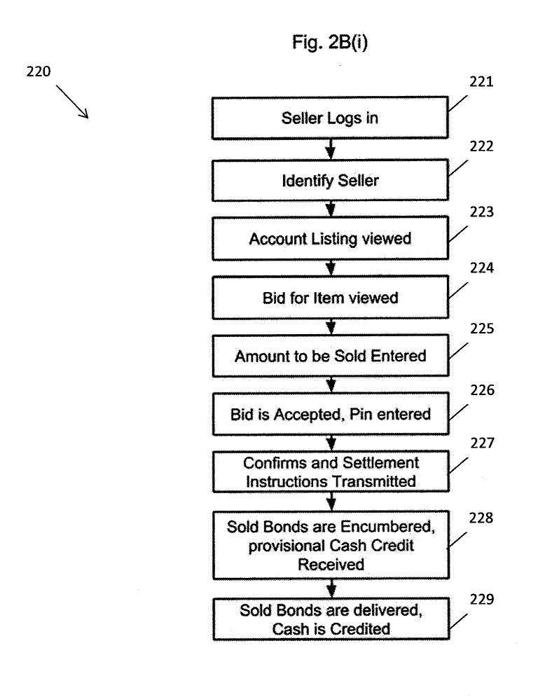

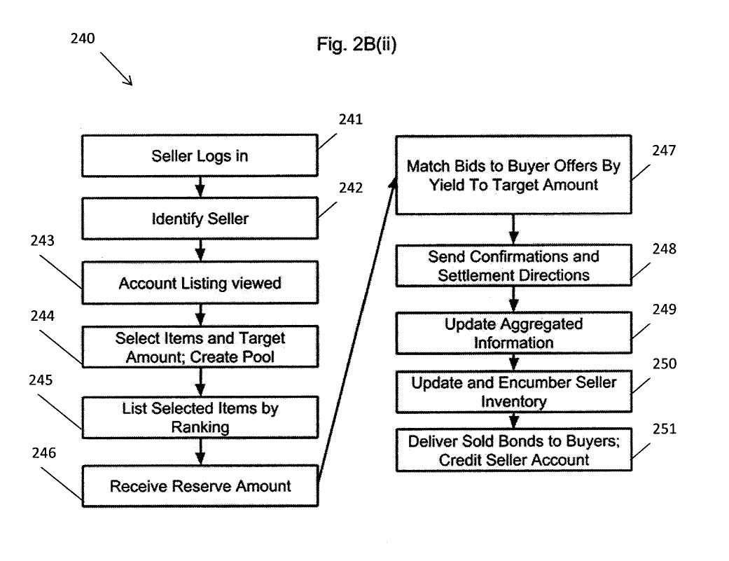

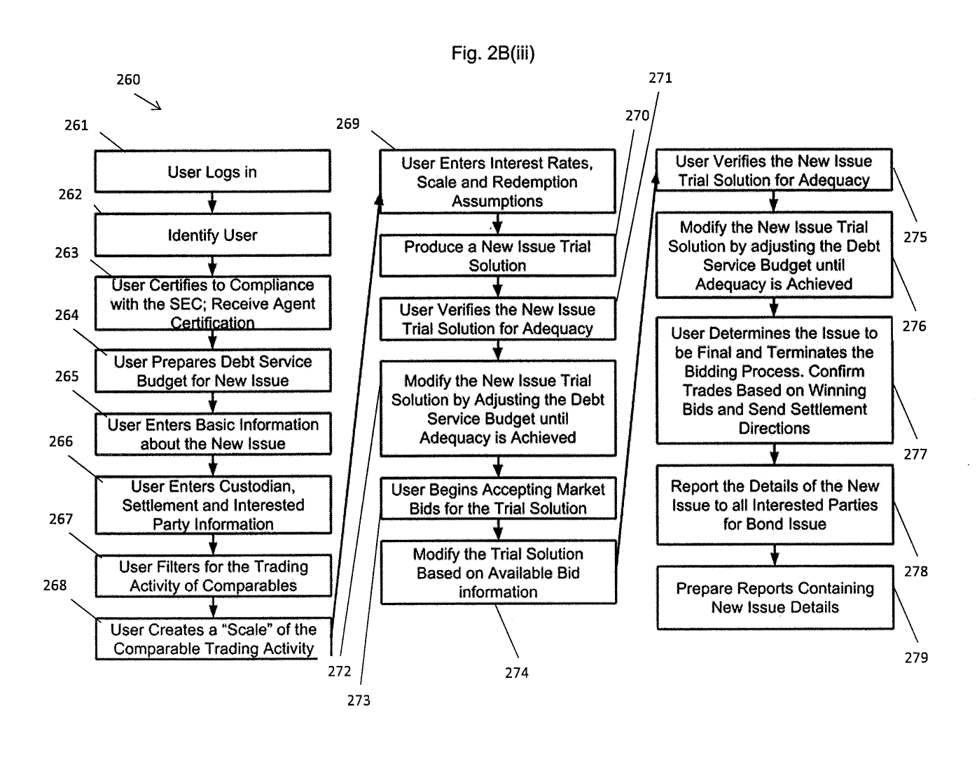

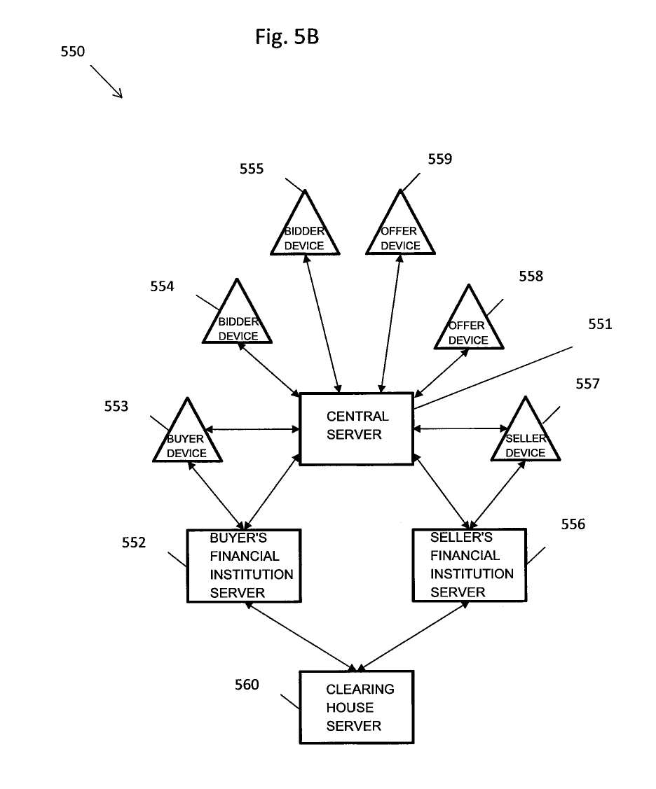

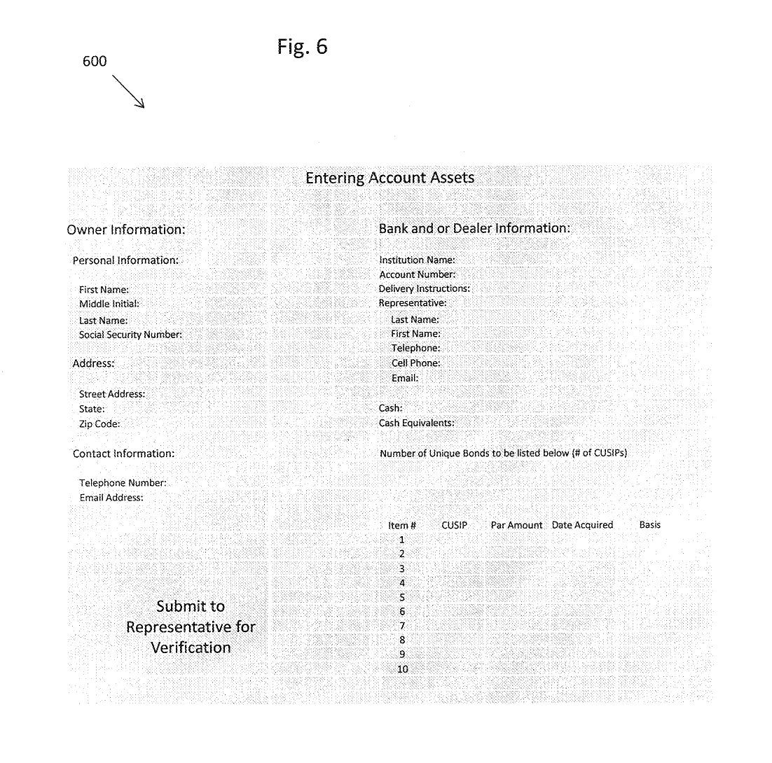

Various embodiments of the operation of an exchange system are illustrated in FIGS. 1, 2A, 2B(i), 2B(ii), 2B(iii), 3A, 3B(i), 3B(ii) and 4. Referring to FIG. 1, a method 100 for initializing a user (e.g., a bond owner, seller or bidder) within the exchange system is shown. An example of a graphical user interface for a user device, to enable execution of one or more steps in the method 100, is shown in FIG. 6.

In step 101, a user logs in to access the exchange system. The exchange system may require the user to provide authentication credentials that verify the user's identity and allows access to the system. For example, the user may be required to input a username and password, client-side certificate, one-time password and PIN, or other credentials that uniquely identify a specific user. Third party authentication tools may also be used, such as OAuth and OpenID. Users who are new to the exchange system may be required to establish a username and/or password or PIN. Users may have multiple accounts within the exchange system, each with its own username and password or PIN.

In a preferred embodiment, the exchange system is configured to allow the user to input authentication credentials from a client device to the central server of the exchange system over a computer network, and the authentication information is stored in the system database. In a further embodiment, when the exchange system is accessed through the Internet using a web browser or similar application, the system may inject a cookie within the web browser to reference the user's session with the system.

In a further preferred embodiment, the exchange system assigns an anonymous, unique identifier to each user. The users of the exchange system are identified to each other solely by their anonymous identifier. The use of an anonymous identifier provides security for the user and reduces any bias that may exist for or against a particular user. For example, a seller may have a conscious or subconscious preference to sell to bidders that represent institutions rather than individuals. The use of an anonymous identifier makes all bidders equivalent to the seller, and levels the playing field for individuals versus institutions.

In step 102, the user inputs personal information to the system. Personal information may include, but is not limited to, name, address, telephone number, birthday, Social Security Number, and/or other information that is personal to the user. Personal information may be inputted to the exchange system through a number of different ways—e.g., through an online registration form, in a text box, check box and/or in other ways that are known in the art. It should be appreciated that this step is optional and that the system may already have stored the user's personal information from a previous login or registration. In an alternative embodiment, the exchange system may obtain the user's personal information from other sources. For example, if the user authenticates in step 101 through OpenID or OAuth, then the system may retrieve the user's personal information from an associated social-media outlet, such as, for example, Facebook.

In step 103, the user inputs information identifying a financial institution for withdrawing and depositing the user's funds during successful offers and bids mediated by the exchange system. For example, the financial institution may comprise one or more bank accounts, and the inputted bank information may include the institution name, routing number, account number, bank representative, delivery instructions and/or other information. It should be appreciated that the exchange system may interact with one or more user accounts through communication with a financial institution using an application programming interface provided by the financial institution. In a preferred embodiment, the user provides bank information sufficient to allow the exchange system to direct the deposit or withdrawal of the user's funds during the various transactions and other processes described herein.

In step 104, the user inputs information identifying the securities held by the user, and identifies the financial or custodial institution that holds those securities. In a preferred embodiment, the information identifying municipal bonds that is inputted to the exchange system includes the Committee on Uniform Security Identification Procedures (CUSIP) number and par value of the bond. A CUSIP number is provided for each municipal bond and uniquely identifies the specific municipal bond. Additional information may be inputted, such as the bond acquisition date, yield basis, coupon rate, maturity and/or dollar value. The inputted information is stored in various fields of the database.

In step 105, the exchange system communicates with the financial and/or custodial institutions to verify the information inputted in steps 103 and 104—e.g., to verify that the user holds funds in the identified account and/or to verify that the user has ownership and title to the securities in the identified custodial institution. In one embodiment, the exchange system may verify the user's account information using an application programming interface provided by the financial institution. In a further embodiment, the exchange system may perform a small withdrawal from the user's account to verify the financial institution information.

In step 106, the user may input agent information to allow the agent to access the exchange system and to act on the user's behalf. For example, the user may authorize an agent to act on behalf of the user within the exchange system to place bids, offers, and generally perform transactions. It should be appreciated that an agency is not required.

In step 107, the exchange system may retrieve additional information regarding the identity and/or characteristics of the securities inputted to the system. In a preferred embodiment, the exchange system maintains a predefined set of information about each municipal bond that is inputted by a user in step 104 or is otherwise recorded within the exchange system. The predefined set of information provides the user with an accurate and current representation of the user's portfolio of municipal bonds and facilitate comparison with other bonds having varying characteristics. The set of information may include the information inputted by the user in step 104—e.g., the CUSIP number, par value of the bond, bond acquisition date, yield basis, coupon rate, maturity and/or dollar value—which are stored in various fields of the database.

To the extent that the information in the predefined set is incomplete, the exchange system may use the information that has been inputted by the user to derive additional information relating to the securities, or retrieve additional information from other sources. For example, the exchange system may calculate the yield basis of a bond for the next known maturity or settlement date, based on the applicable tax law. The exchange system may also retrieve additional information by accessing external sources that are known in the art, such as the user's custodial institution, the Electronic Municipal Market Access (EMMA®) system provided by the Municipal Securities Rulemaking Board and/or other sources that are known in the art. Those of skill in the art will appreciate that much of the information about a municipal bond may be obtained from external sources based on the bond's CUSIP number, or can be calculated from information available from external sources. However, in the case of new issues of municipal bonds where the initial bond offering is through the exchange system, the user may be required to provide such information.

In step 108, the exchange system may assign a unique identification code for the securities inputted in step 104 or that are otherwise recorded within the system. In a preferred embodiment, the unique identification code is assigned by the exchange system when the securities are inputted by the user in step 104. In the case of municipal bonds, the unique identification code is assigned distinct from the corresponding CUSIP number of the bond, as well as where the bond may not have a CUSIP number. In either case, the exchange system generates a unique identification code for the municipal bond to facilitate the identification and administration of the bond within the system.

Referring now to FIG. 2A, a method 200 for purchasing securities (e.g., municipal bonds) within an exchange system is shown. The exchange system provides a platform for users to place bids on available municipal bonds for purchase and offer to sell municipal bonds, and maintains a database of all bids, offers, pending transactions, and cleared transactions.

In step 201, a user/bidder logs in and provides authentication credentials to the exchange system, such as the username and password or PIN described in step 101. In step 202, the exchange system identifies the user based on the login and authentication information.

In step 203, the user initiates a search of the municipal bonds that have been stored in the exchange system database to identify one or more bonds that the user is interested in purchasing. The user inputs one or more preferences, value determinants or other criteria to query against the municipal bond information maintained in the exchange system database (e.g., as described in steps 104 and 107) and filter the bonds within the system. The filtering criteria may include: the type of municipal bond, the State or territory where the bond was issued, the tax treatment of the bond, a range of years to maturity, a minimum call protection in years, a minimum rating of the issuer as identified by a rating provider (e.g. S&P, Moody's, Fitch), the bond's performance relative to a benchmark, a coupon type of the municipal bond, a coupon range and/or or other bond characteristics as are known in the art.

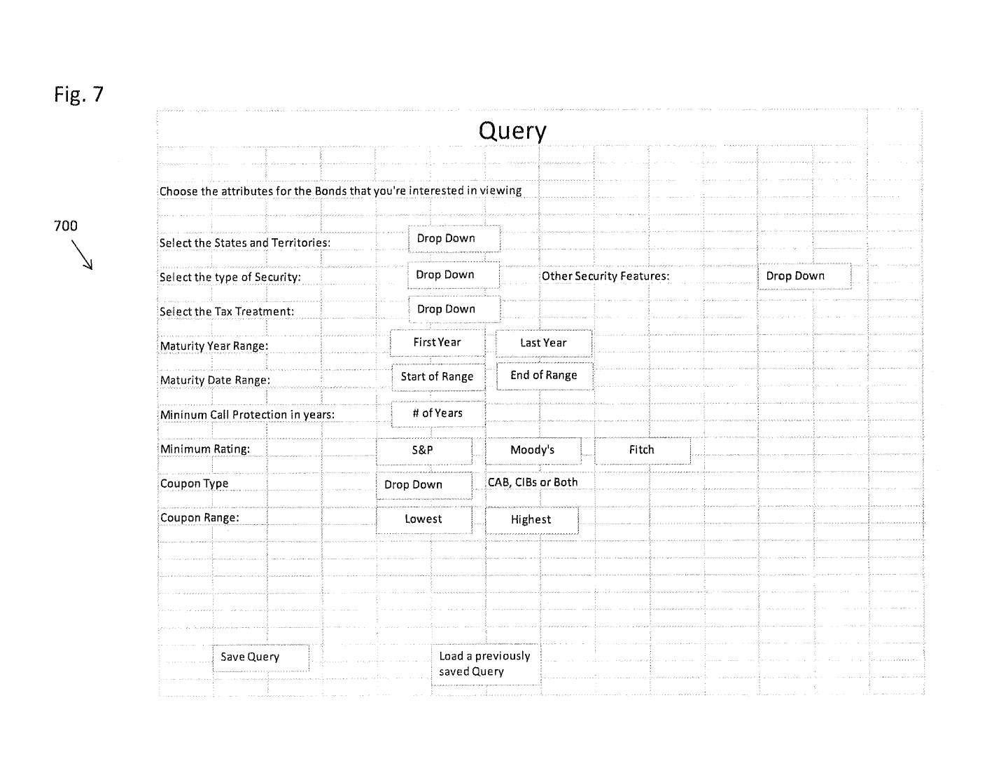

An embodiment of a graphical user interface enabling a user to query the exchange system is shown in FIG. 7. For example, a user may be interested in purchasing municipal bonds issued in the State of Illinois with a maturity date range between 2020 and 2024. The user may input a query against the exchange system by selecting the State of Illinois, a maturity date range between 2020 and 2024, and any other user selected criteria.

In step 204, the exchange system filters the municipal bonds within the exchange system based on the inputted criteria, and generates and displays the query results as a list of the municipal bonds that satisfy the inputted criteria. These results constitute a group of municipal bonds that the user may consider to be economic equivalents with respect to the query criteria.

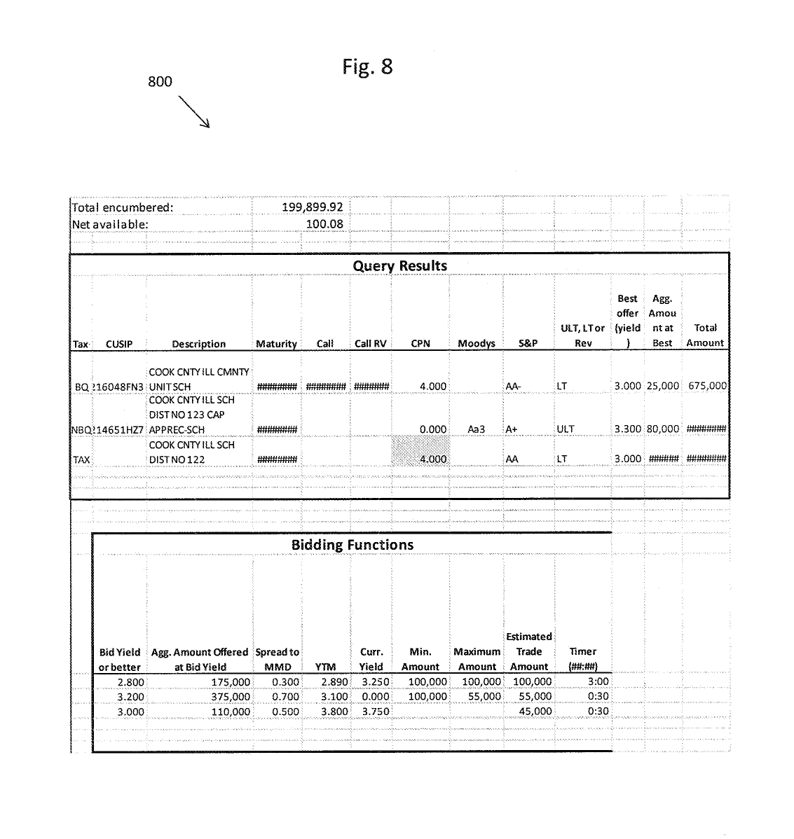

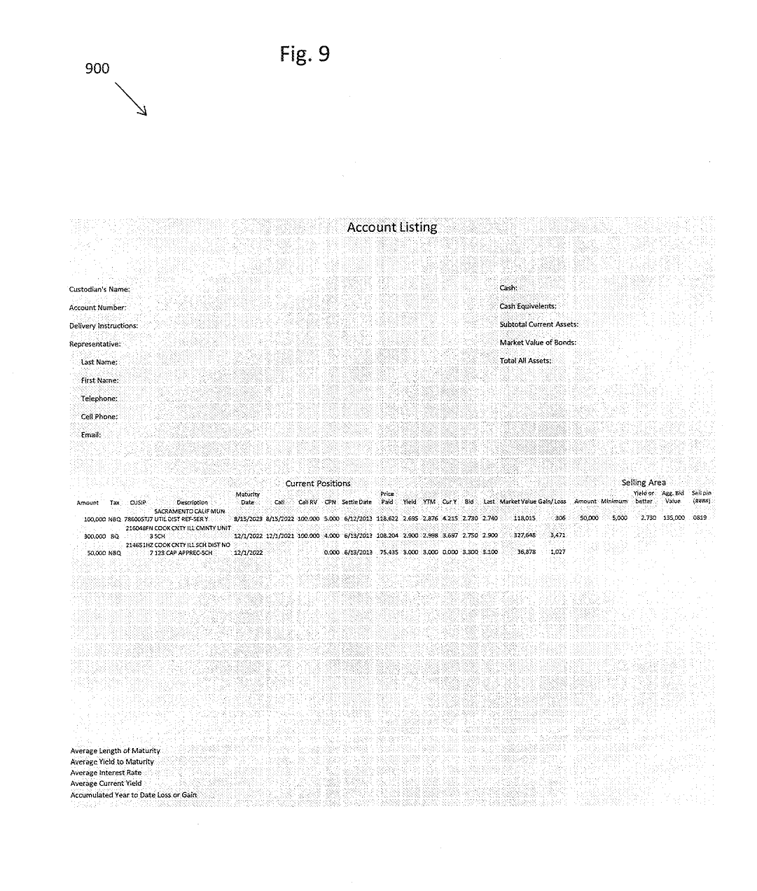

In a preferred embodiment, the displayed list of municipal bonds includes information that relates to the value of the bonds or that otherwise assists the user in comparing the bonds. This information may be retrieved from the database and/or calculated by the exchange system. For example, the exchange system may retrieve information from the database such as the CUSIP number, a tax identifier, an amount, maturity date, a call date, a settlement date, the price paid in recently cleared trades for the municipal bond, the current yield, yield to maturity, the highest bid, the last bid, the market value, calculated gain and loss information, and other information. The exchange system may also calculate the market value for each selected bond based on the current price and yield indicated under the highest bid or, alternatively, last known bid. The expected gain or loss for such a transaction may be calculated based on the difference between the amortized basis for the position in each municipal bond and the market value, whereby a positive value is a gain and negative value is a loss. In a further preferred embodiment, the exchange system allows the user to sort the list of municipal bonds by the type of displayed information—e.g., the current yield. An example of a display showing the results of a query is shown in FIG. 8. The information may be displayed by various means known in the art and appropriate to the type of user device, such as a customized web page, mobile application screen, or other information pane.

In step 205, the user reviews and analyzes the query results displayed in step 204 and may input a selection of one or more of the listed bonds for purchase. In one embodiment, the user may create a bond purchase pool comprising a group of municipal bonds. For example, the user may use the query results in step 204 to identify a set of municipal bonds that are considered to be economic equivalents—e.g., that have the same desired yield and/or other user selected criteria. The user then selects two or more municipal bonds in the identified set to form a group or pool of bonds, each of which is identified by a unique CUSIP number or other unique identification code.

In step 206, the user inputs bid information for the municipal bond or bonds selected for purchase in step 205. For example, the user may input a bid comprising a desired yield for the maturity date (yield basis). The input may also include other purchase criteria, such as the minimum or maximum purchase amount. The user's selection of purchase criteria may be guided by the query results in step 205. For example, if a query informs a user that the current best offer for a particular bond is 2.79% yield, the user may desire to see if a bid for this bond at 2.80% yield will be accepted. In another example, the user may reference rating criteria provided by S&P, Moody's, Fitch, or any other rating provider to determine the likelihood of the user collecting on the bond at the time of maturity. It should be appreciated that the totality of information presented to the user during the bidding process enables the user to create an educated purchase pool to bid on municipal bonds based on market data.

In a preferred embodiment, a user interested in purchasing municipal bonds within the exchange system may input preferences for an allocation of funds (e.g., cash)—i.e. to set and commit a specific amount of funds for purchases to be made through the system. The exchange system may encumber the user's allocated funds and maintain the total amount of funds necessary to execute the user's subsequent transactions. The user would not be permitted to use the encumbered funds for another transaction, or otherwise withdraw the committed funds. The exchange system may display the encumbered funds information to the user through a graphical user interface.

In the case of a bond purchase pool, the user inputs a bid against the bond purchase pool that may be filled by any one bond or a combination of bonds in the group, up to the amount of allocated funds. The bond purchase pool effectively allows the user to simultaneously bid on all of the desired individual municipal bonds within the group.

In step 207, the exchange system calculates the amount of funds required to complete a transaction should the user's bid be successful and communicates with the user's financial institution (e.g., as identified in step 103) to encumber the required funds. For example, the exchange system may communicate with the user's financial institution to confirm that the user holds sufficient funds to meet an allocation of funds in step 206, and directs the financial institution to encumber those funds. In step 208, the exchange system receives verification from the user's financial institution that the appropriate funds have been encumbered.

In step 209, the exchange system transmits the user's bids to all user/owners of the corresponding bonds within the system. The exchange system also makes the user's bid information available to all users of the system by recording the user's bids in an Order Book that is maintained in the database for each of the municipal bonds. The Order Book comprises a record of current bids and offers for each bond and is accessible by all users of the exchange system—e.g., when querying existing bids and known municipal bonds as in step 203. In a preferred embodiment, the exchange system requires that the user's funds are encumbered before the bid information is transmitted to owners of the bonds. Thus, the exchange system provides assurance to the bond owners that all bids are backed by sufficient funds.

In step 210, the exchange system receives confirmation from any user/owners of the corresponding municipal bonds that choose to accept the bids inputted in step 206. In step 211, the exchange system processes the bids by comparing and filling each bid against all offers for sale of the relevant municipal bond to form one or more transactions. The offers for sale may comprise both existing offers for sale and offers for sale received in step 210. The exchange system updates the database as the transactions are formed to reflect the filled or partially filled bids and the corresponding accepted offers.

In a preferred embodiment, the exchange system fills the user's bid according to price and by the time of entry of the offer for sale. For example, the exchange system may fill the user's bid from those offers for sale where the offered yield meets or exceeds the bid yield, with preference given to the highest yield. Thus, the user's bid will first be filled from offers for sale at a higher yield than the bid yield, and then from offers for sale at the bid yield. In the case where there are multiple offers for sale for the same yield, the bid will be filled from those offers for sale on a first come, first served basis. The exchange system updates the database in real time as the bid is filled.

In the case of a bond purchase pool, the purchase pool bid is processed against all known offers for sale of the bonds in the pool. Offers for sale of the pool bonds may already exist in the exchange system that immediately meet or exceed the purchase pool bid placed by the user in step 206. The exchange system determines whether the purchase pool bid—e.g., the bid yield, minimum purchase amount or other purchase criteria—can be filled by an aggregate of one or more offers. As transactions are formed to fill the purchase pool bid, the exchange system updates the database to reflect the corresponding reduction in the bidder's allocation of funds.

For example, a user allocates funds and selects a bond purchase pool that seeks to purchase $100,000 of CUSIP number 123456AB1 at a 2.80% yield. After placing this bond purchase pool bid, the exchange system sends a communication to all owners of CUSIP 123456AB1 that a bid has been made for $100,000 at 2.80% yield. In this example, the total par amount of CUSIP 123456AB1 known to the exchange system is $675,000. Therefore, the bond purchase pool bid would only be reconciled and a transaction executed with the first $100,000 of sellers that are willing to sell and accept the bid for 2.80% yield. All other sellers interested at this yield would have to wait for a future bidder.

In step 212, the exchange system transmits the updated bid and offer information to all user/owners of the corresponding bonds within the system. The exchange system also makes the updated bid and offer information available to all users of the system by updating the corresponding Order Book. In one embodiment, steps 209 to 212 may be looped in any order until the bid is completely filled or is canceled by the user. The exchange system will periodically retrieve known information about each municipal bond associated with a user, query whether new bids, offers, and/or transactions are associated with each municipal bond, calculate gain and loss information related to current market values, and then display this information to provide the user with an accurate and current depiction of the municipal bonds inputted by the user into the system.

In step 213, the exchange system ends the bid process once the bid is completely filled or the user cancels the bid. Any transactions that have been formed are settled by transferring the corresponding funds and securities. To the extent that a bid is unfilled or only partially filled, the exchange system cancels the encumbrance of the user's remaining funds.

In a preferred embodiment, the exchange system communicates with the relevant third party financial institutions to verify that the bidder's funds and seller's municipal bonds are available for transfer. For example, the exchange system may interact with third party financial institutions using an application programming interface provided by the third party financial institution to withdraw funds, query the status of owned securities, and otherwise interact with a user's financial institution to effect the transaction. The user may also provide the exchange system with credentials to the user's financial institution to deduct funds for purchase of bonds and, if the user is a seller, transfer securities from the seller to the buyer. In an alternative embodiment, the exchange system may present a contract for signature between the buyer and seller to effectuate the transaction through contract.

In yet another embodiment, the transaction may also be settled through a clearing house, such as the Depository Trust Company. The exchange system may provide the user with the ability to select the clearing house.

Referring now to FIG. 2B(i), a method 220 is shown for the sale of municipal bonds within an exchange system. In steps 221 and 222, the user/owner or user/seller logs into and is identified by the exchange system in the same manner as in steps 201 and 202.

In step 223, the exchange system displays a listing of the user's portfolio of municipal bonds within the system. In one embodiment, the exchange system further displays a listing of all bids within the system that have been placed against those bonds. In yet another embodiment, the user may filter and display the bonds that he or she holds by querying one or more value determinants or other criteria against his or her portfolio of bonds within the exchange system, in the same manner as described in steps 203 and 204. For example, the user may query his or her bond portfolio based on CUSIP number, maturity date, purchase price, market value, yield, bond rating, and other information.

In step 224, the user may input a selection of one or more bonds to be offered for sale from the listing or filtered listing displayed in step 223. Alternatively, the user may select and accept one or more bids displayed in step 223, and proceed to step 226.

In step 225, the user inputs a sale allocation or offer for sale that defines a target amount of held bonds that the user intends to sell. In one embodiment, the offer for sale may be inputted as the desired yield and dollar amount, or redemption and par value for each of the selected bonds. For example, a user may input a sale allocation of $200,000 of redemption value in the selected bond.

In yet another embodiment, the user may create a bond sale pool comprising a group of selected bonds. For example, the user may use the query results in step 223 to identify and select a set of two or more bonds in a similar manner as the bond purchase pool in step 205. The user inputs an offer for sale of the bond sale pool that may be filled by any one or a combination of bonds in the group, up to the sale allocation.

In step 226, the exchange system transmits and processes the offer for sale in a similar manner to steps 209 to 212, except from the seller's side. Similarly to step 209, the exchange system transmits the user's offer for sale to all bidders for the corresponding bond and makes the offer for sale available to all users of the system by updating the exchange system Order Book. The offer is viewable by all users of the exchange system—e.g., when querying existing offers and known municipal bonds within the system. Similarly to steps 210 to 212, the exchange system receives confirmation of bids that accept the offer for sale, processes the offer for sale against existing and received bids, updates the database to reflect the transactions that are formed, and transmits the updated offer and bid information to all users of the system. In a preferred embodiment, the exchange system requires the entry of the user/seller's password or PIN to accept a bid and form a transaction.

In step 227, the exchange system transmits confirmation of the transaction to the appropriate bidder. The exchange system ends the sale process once the offer for sale is completely filled or the user cancels the offer, similarly to step 213.

In one embodiment, the exchange system may accommodate the delays in consummating real world transactions. Although the exchange system is capable of forming and settling transactions effectively instantaneously, the real world process of transferring funds and securities may take days to settle. In step 228, the exchange system accommodates these real world delays by assigning a date and time for each transaction and encumbering the funds and securities involved in the transaction. In a preferred embodiment, the date and time is assigned based on the U.S. Eastern Time Zone, to reflect the fact that most municipal bond transactions are domestic. In a further preferred embodiment, the exchange system may also enter a provisional cash credit to the user/seller's account within the system.

In step 229, the exchange system settles the transactions that have been formed by transferring the corresponding funds and securities, as in step 213.

Referring now to FIG. 2B(ii), an embodiment of a method 240 for the sale of municipal bonds using pool aggregation is shown. In steps 241 and 242 the user/seller logs into and is identified by the exchange system, as in steps 221 and 222. In step 243, the exchange system displays, or filters and displays, a listing of the user's portfolio of municipal bonds within the system, as in step 223. In step 244, the user selects the bonds to be offered from the listing in step 243 and inputs a sale allocation to create a bond sale pool, as in steps 224 and 225.

In step 245, the exchange system displays a sorted list of the bonds in the user's selected bond sale pool. For example, the exchange system may sort and display the bonds according to the current bid yield—e.g., according to the highest bid price and lowest yield. In a preferred embodiment, the bonds in the bond sale pool are sorted and displayed according to a user selected value determinant or other criteria.

In step 246, the user may input an amount to be reserved against one or more of the bonds in the displayed list. The seller may not wish to sell the entire position of one or more bonds in the user's portfolio. Thus, the exchange system allows the user to designate a portion of the user's holdings to be withheld from the bond sale pool.

In step 247, the exchange system processes the bond sale pool against all existing and received bids to determine whether any transactions can be formed, in a similar manner as in step 226. The exchange system determines whether the bids meet, in aggregate, the sale pool offer—e.g., the desired yield and dollar amount, redemption and par value, or other offer criteria in step 244—and processes offers against bids until the sale allocation or target amount is reached.

For example, a seller holding $200,000 of municipal bonds with the CUSIP 123456AB1 may choose to sell $150,000 of these bonds at a desired yield of 3.0%. The user may query the exchange system to filter and display the bonds within his or her portfolio based on the CUSIP number or other information. The user inputs a sale allocation and selects the appropriate bonds to form a bond sale pool at $150,000 and 3.0% yield for CUSIP 123456AB1. This bond sale pool offer is communicated to all users in the exchange system and processed against all standing bids. In the event that a bid or bids exist or are subsequently placed that match the bond sale pool offer, the exchange system reconciles the offer and a transaction or set of transactions is executed with the first $150,000 of bidders that are willing to buy and accept the offer for 3.0% yield. All other bidders interested at this yield would have to wait for a future offer.

In step 248, the exchange system transmits confirmation of the transaction to the appropriate bidder or bidders, and ends the sale process once the offer for sale is completely filled or the user cancels the offer, as in step 227. In step 249, the exchange system may assign a date and time for each transaction and encumber the funds and securities involved in the transaction, as in step 228. In step 250, the exchange system settles the transactions that have been formed by transferring the corresponding funds and securities, as in step 229.

Referring now to FIG. 2B(iii), a method 260 for the sale of municipal bonds for the first time (new issues) is shown. Issuers of municipal bonds commonly engage an agent or other representative, such as a municipal advisor, to advise on, oversee and manage the issuance of new bonds. In steps 261 and 262, the user/issuer/agent logs into and is identified by the exchange system, as in steps 221 and 222. In a preferred embodiment, the exchange system also confirms that the user is authorized to act on behalf of the issuer. For example, the exchange system may confirm that the user has been identified by the issuer as an agent (e.g., in step 106).

In step 263, the exchange system provides for verification by the user that it is in compliance with any applicable securities laws and/or regulations, such as those established by the Securities and Exchange Commission (SEC), including contractual obligations arising thereunder. In one embodiment, the exchange system displays a statement that the user is in compliance with the legal requirements, rules and/or regulations, including contractual obligations arising thereunder, applicable to new issues. The user is then required to input confirmation of the user's agreement to the statement in order to proceed. It should be appreciated that, depending on the applicable legal and other requirements or the features of the new issue, the specific statements and inputs may differ to conform to such requirements or features.

In step 264, the user inputs a budget for service of the debt created by the new issue. In a preferred embodiment, the inputted budget comprises a schedule of debt service payments over time. For example, the budget for a 10 year bond may comprise a schedule of 10 annual payments. In a preferred embodiment, the exchange system attempts to tailor the new offering to the inputted budget.

In step 265, the user may input additional features and properties of the new issue. For example, the user may input: the desired amount to borrow, the date of issue, the dates of the principal payments, the frequency of the interest payments, the call date, the tax status and/or other features as are known in the art.

In step 266, the user inputs custodian information. For example, the user may identify the financial institution that will administer the bonds, receive deposits of the purchase funds and make interest payments as trustee. In a further embodiment, the user may also input information relating to other participants in the new issue, such as the identity of the law firm providing the legal opinion for the new issue and/or the identity of the agency rating the new issue.

In step 267, the user may use information about other bonds in the exchange system as a basis for determining an appropriate interest rate for the new issue. For example, the user may filter the bonds within the exchange system to generate and display a listing of comparable bonds, in a similar manner as in steps 203 and 204. The listing of comparable bonds may provide the user with a range of applicable interest rates.

In step 268, the user inputs a schedule or scale of expected or proposed interest rates that correspond to the maturity dates of the new issue.

In step 269, the user inputs the expected or proposed redemption properties of the new issue. For example, the user may input: the dates of maturity, interest rate, yield and/or early redemption option, if any. In a preferred embodiment, the inputted redemption properties comprise a schedule or array of payments to be made at each maturity date over the life of the bonds.

In steps 270 to 272, the exchange system determines whether the user's expected features and properties of the new issue are consistent with the user's inputted budget. In step 270, the exchange system calculates and determines whether a new issue based on the expected redemption properties in step 269 is consistent with the features and properties inputted in step 265. In step 271, the exchange system determines whether a new issue based on the expected redemption properties in step 269 is consistent with the budget inputted in step 264. In step 272, the exchange system permits the user to modify the budget inputted in step 264. Steps 270 to 272 are then looped until steps 270 and 271 are satisfied and an adequate budget has been inputted.

In step 273, the exchange system makes the new issue available to all users of the system and receives bids from interested users. In step 274, the exchange system adjusts the budget based on the interest in the new issue. Those of skill in the art will appreciate that no interest rate is set for new issues. Rather, the bidders set the interest rate. For example, if the new issue is oversubscribed such that interest rates are lower than expected, then the exchange system will enter a corresponding reduction in the budget. In a preferred embodiment, the exchange system ranks the bids for the new issue according to the highest bid price and lowest yield and determines an adjustment to the budget in the aggregate. In a further preferred embodiment, the exchange system makes adjustments to the budget based on bids entered into the system in real time.

In step 275, the user reviews the adjustments to the budget to determine whether they are acceptable to the issuer. In step 276, the user may make adjustments to the budget such that the new issue is acceptable to the issuer and is consistent with the interest in the new issue.

In step 277, the user inputs confirmation that the new issue is final and the exchange system ends the bidding process. The exchange system confirms accepted bids based on the highest bid price and lowest yield, and the time of entry of the bid. The exchange system further updates the database to reflect the confirmed bids.

In step 278, the exchange system settles the confirmed bids by transferring the corresponding funds and securities. Those of skill in the art will appreciate that the sale of new issues may require an opinion of qualified bond counsel and often involves significant paperwork requiring signature. Thus, there is commonly a delay between the sale of a new issue and the actual settlement of the transaction. In an alternative embodiment, the exchange system may confirm bids by transmitting the future settlement date and indicating when and where to transfer the funds. For example, the exchange system may issue a notice of debts to the user/bidders. The user/bidder's funds may also be encumbered until the transaction is settled.

Those of skill in the art will also appreciate that the municipal advisor for the issuer often must prepare and provide a report of the new issue to the issuer and the issuer's financial institution involved in the new issue. In step 279, the exchange system may generate a report of the new issue or otherwise assist the user to prepare such a report.

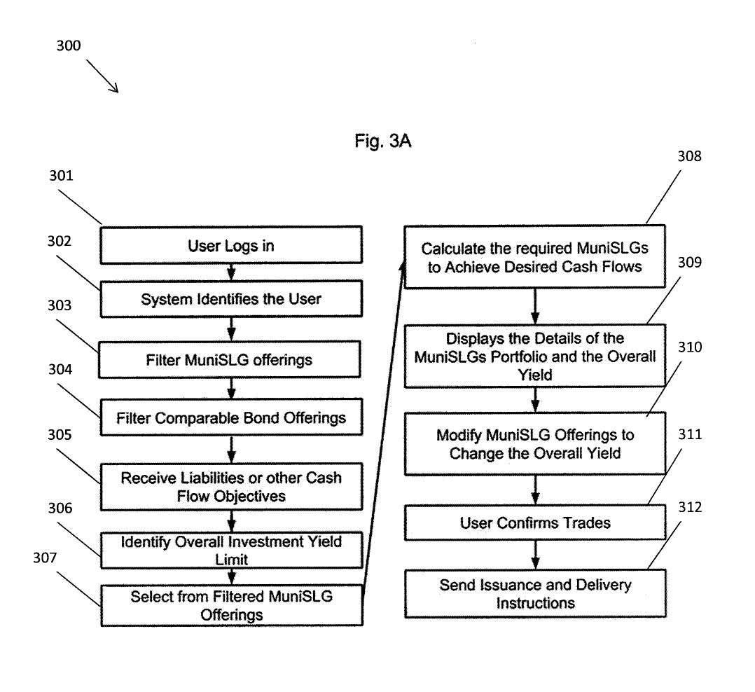

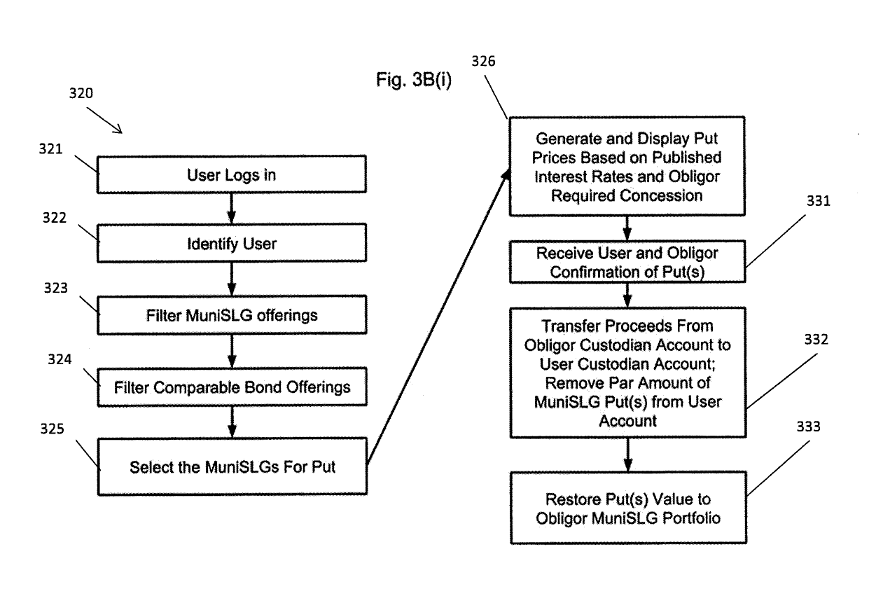

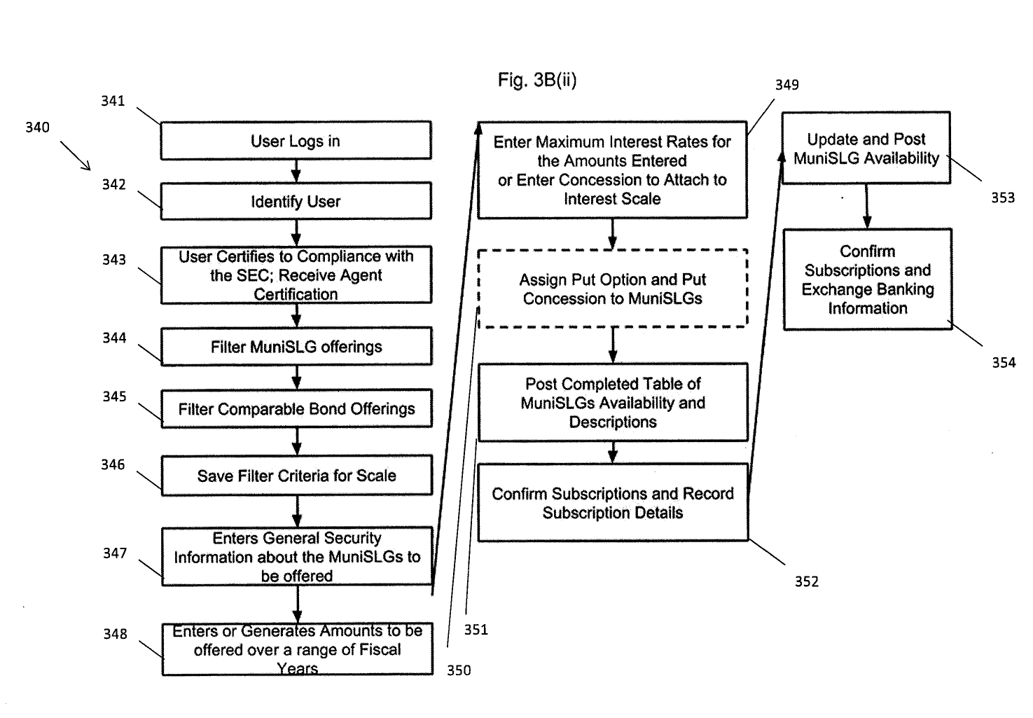

In another embodiment, the exchange system may also be configured to enable transactions in MuniSLGs. Referring now to FIG. 3A, a method 300 for the purchase of MuniSLGs is shown, that comprises the steps of: authenticating a user in step 301, identifying the user in step 302, filtering available MuniSLGs based on user criteria in step 303, filtering comparable bond offerings in step 304, entering liabilities or other cash flow objectives in step 305, identifying an overall investment yield limit in step 306, selecting from the available MuniSLG offerings that were filtered in step 307, calculating the required MuniSLGs to achieve the desired cash flows in step 308, displaying the details of the MuniSLGs portfolio and the overall yield of such portfolio in step 309, modifying the MuniSLG offerings to change the overall yield in step 310, confirming trades in step 311, and sending issuance and delivery instructions in step 312.

In step 301, the exchange system authenticates a user. As discussed previously, in step 301, a user attempting to access the exchange system may be required to provide authentication credentials to verify the user's identity. For example, the user may input a username and password, client-side certificate, one-time password and PIN, or other credentials that uniquely identify a specific user. Third party authentication tools may also be used, such as OAuth and OpenID. In a preferred embodiment, the authentication credentials are inputted from a client device to the central server of the exchange system over a computer network, and the authentication information is stored in the system database. In a further embodiment, when the exchange system is accessed through the Internet using a web browser or similar application, the system may inject a cookie within the web browser to reference the user's session with the system.

In yet another embodiment, the system may also verify that the authenticated user is authorized to perform activities within the exchange system.

In step 302, the exchange system identifies the user based on the credentials provided in step 301. By identifying the user, the exchange system determines the user's associated personal information, bond information, financial institution account information, any configured agents, and the like. Further, step 302 identifies the authorization that the user is provided thereby indicating what activities the user may perform within the exchange system, such as, for example, buying and selling municipal bonds.

In step 303, the user/buyer filters and displays the MuniSLGs within the exchange system by querying one or more value determinants or other criteria against the MuniSLGs maintained in the exchange system database. For example, the MuniSLGs may be filtered by searching for criteria such as: issuer, security type, target yield, and rating by a rating provider. In one embodiment, the user may access the exchange system through an account where MuniSLGs are offered for subscription.

Users interested in buying or subscribing to MuniSLGs may further desire to find MuniSLGs that meets specific tax benefits, tax requirements, or other criteria. In step 304, the user inputs the desired future bond liabilities, bond values or other desired features of the MuniSLGs to filter from the global set of comparable bond offerings. The user may then enter liabilities or other cash flow objectives into the system in step 305 to identify attributes related to the MuniSLGs that the user is interested in obtaining. It should be appreciated that the system may be configured to enable a user to filter a global set of MuniSLG offerings based on a variety of attributes, including, without limitation, desired yield, issuer, maturity date, and other attributes. The user may also enter an overall investment yield limit in step 306 to further filter the global offering of MuniSLGs within the system.

In step 307, the user selects one or more MuniSLGs from the filtered list to identify MuniSLGs that the user may be interested in purchasing. Then, in step 308, the inputted features and selected MuniSLGs are queried within the exchange system to identify and display the optimal selected MuniSLGs for the desired features. For example, the exchange system may determine the optimal MuniSLGs based on maximizing amounts at appropriate maturity dates in correspondence with applicable tax codes. In one embodiment, the exchange system may determine the optimal MuniSLGs using the available interest rates for SLGS issued by the United States Treasury Department as a baseline for comparison to the MuniSLGs interest rates offered within the exchange system. The exchange system may obtain the SLGS interest rate information by communicating with the SLGSafe system maintained by the United States Treasury Department.

The exchange system in step 308 may also calculate a minimum required for a prospective subscription, based upon current interest rates and/or issuer's target yield. For example, the current interest rates may be the average or highest interest rate of MuniSLGs offered within the exchange system, or the interest rate of corresponding SLGS securities available from the United States Treasury Department.

In step 309, the exchange system displays the detailed results of a prospective subscription to the MuniSLGs selected in step 307, as determined in step 308. For example, the displayed results may include the cost of the MuniSLGs, available cash flow, selected yield, and other information. By presenting the virtual results of the purchase, the exchange system allows the user to confirm whether a subscription complies with the user's intentions and the appropriate tax codes before encumbering any funds.

In step 310, the user may modify his or her selection of MuniSLGs to change the overall yield of a MuniSLG purchase, which then causes the system to change the presentation of information in steps 308 and 309 through a graphical user interface. The user may repeat these selection and evaluation steps until the user has identified and selected a set of MuniSLGs that satisfies the user's requirements.

In step 311, the user confirms any trades and contracts for a subscription to the selected MuniSLGs. Contracting for a MuniSLG subscription may follow the same process as described for processing a transaction between a buyer and seller in methods 200 and 220 described above, including communicating with third party financial institutions and a clearing house to effect the transaction. In step 312, the exchange system may send wire instructions to financial institutions and report on the subscriptions to both the user and issuer.

Referring now to FIG. 3B(i), a method 320 for selling MuniSLGs through an exchange system is shown, that includes the steps of: authenticating a user in step 321, identifying the user in step 322, filtering MuniSLG offerings in step 323, filtering comparable bond offerings in step 324, selecting the MuniSLGs to be offered for put options in step 325, generating and displaying put prices based on published interest rates and obligor (i.e., the issuer) required concessions known to the system in step 326, receiving user and obligor confirmations of put options based on matching offers and requests in step 331, transfer proceeds from obligor custodian accounts to user custodian accounts and remove the appropriate par amount of MuniSLG put options from user accounts based on confirmations in step 332, and restore put values to obligor MuniSLG portfolio in step 333.

It should be appreciated that the sales of MuniSLG put options within an exchange system may follow the methods already described herein for general municipal bonds. It should be appreciated that the exchange system may also enable the sale of MuniSLGs in comparison to other bond offerings, such as, for example, through execution of the method 340 shown in FIG. 3B(ii).

In step 321, the exchange system authenticates a user. As discussed previously, in step 321, a user attempting to access the exchange system may be required to provide authentication credentials to verify the user's identity. For example, the user may input a username and password, client-side certificate, one-time password and PIN, or other credentials that uniquely identify a specific user. Third party authentication tools may also be used, such as OAuth and OpenID. In a preferred embodiment, the authentication credentials are inputted from a client device to the central server of the exchange system over a computer network, and the authentication information is stored in the system database. In a further embodiment, when the exchange system is accessed through the Internet using a web browser or similar application, the system may inject a cookie within the web browser to reference the user's session with the system.

In yet another embodiment, the system may also verify that the authenticated user is authorized to perform activities within the exchange system.

In step 322, the exchange system identifies the user based on the credentials provided in step 321. By identifying the user, the exchange system determines the user's associated personal information, bond information, financial institution account information, any configured agents, and the like. Further, step 322 identifies the authorization that the user is provided thereby indicating what activities the user may perform within the exchange system, such as, for example, buying and selling municipal bonds.

In step 323, the user/buyer filters and displays the MuniSLGs within the exchange system by querying one or more value determinants or other criteria against the MuniSLGs maintained in the exchange system database. Users interested in selling MuniSLGs prior to maturity may further desire to find MuniSLGs that meets specific tax benefits, tax requirements, or other criteria. In step 324, the user filters the global set of available bond offerings to find comparable bonds to the user's offered MuniSLGs. It should be appreciated that this additional information provides the user with a market price for the put options.

In step 325, the user selects one or more owned MuniSLGs to issue put options. As used in the present disclosure, a put option is an option to sell assets at an agreed price on or before a particular date. In step 325, the user may identify MuniSLGs in which the user would like to sell prior to the MuniSLG maturity date. It should be appreciated that the sale of a MuniSLG prior to the maturity date may require a concession. Therefore, in step 326, the system may determine the market value of the MuniSLGs based on published and current interest rates known to the system in connection with concessions required by obligors for the particular MuniSLGs offered for put options.

In step 331, the user and obligor both may confirm the put option through the system. Then, the proceeds of the sale are transferred from the obligor custodian account to the user custodian account and the par amount of the MuniSLGs that were sold through put option is removed from the user's account in step 332. In such an embodiment, the put options exercised through execution of the method 320 causes the user to realize immediate proceeds from the MuniSLGs prior to the maturity date. However, the proceeds realized by the user in step 332 may be less than the par value of the MuniSLGs in which the put options were exercised.

In step 333, the par value of the MuniSLGs in which the put options were exercised are restored to the obligor's MuniSLG portfolio, thereby closing the transaction. It should be appreciated that the discussion herein has focused on a single MuniSLG put option being exercised in execution of the method 320 but that the method 320 may be exercised with multiple MuniSLGs consecutively or sequentially.

Referring now to FIG. 3B(ii), a method 340 is shown of offering MuniSLGs through an exchange system according to at least one embodiment of the present disclosure. As shown in FIG. 3B(ii), the method 340 includes authenticating a user in step 341, identifying the user in step 342, receiving a certification from a user/agent of compliance with applicable SEC rules and regulations in step 343, filtering MuniSLG offerings in step 344, filtering comparable bond offerings in step 345, saving filter criteria to determine a point of reference for the user (i.e. scale) in step 346, receiving general security information from the user about MuniSLGs to be offered in step 347, receiving or generating amounts to be offered over a range of fiscal years in step 348, receiving the maximum interest rates for the amounts earned in offered MuniSLGs including concessions to attach to the interest scale in step 349, optionally assigning put options and put concessions to the MuniSLGs in step 350, posting a completed table of MuniSLG availability and descriptions in step 351, confirming subscriptions and recording subscriptions dates in step 352, updating and posting MuniSLG availability in step 353, confirming subscriptions to MuniSLGs and exchanging financial institution information to effectuate such subscriptions in step 354.

In step 341, the exchange system authenticates a user. As discussed previously, in step 341, a user attempting to access the exchange system may be required to provide authentication credentials to verify the user's identity. For example, the user may input a username and password, client-side certificate, one-time password and PIN, or other credentials that uniquely identify a specific user. Third party authentication tools may also be used, such as OAuth and OpenID. In a preferred embodiment, the authentication credentials are inputted from a client device to the central server of the exchange system over a computer network, and the authentication information is stored in the system database. In a further embodiment, when the exchange system is accessed through the Internet using a web browser or similar application, the system may inject a cookie within the web browser to reference the user's session with the system.

In yet another embodiment, the system may also verify that the authenticated user is authorized to perform activities within the exchange system.

In step 342, the exchange system identifies the user based on the credentials provided in step 301. By identifying the user, the exchange system determines the user's associated personal information, bond information, financial institution account information, any configured agents, and the like. Further, step 342 identifies the authorization that the user is provided thereby indicating what activities the user may perform within the exchange system, such as, for example, buying and selling municipal bonds.

In step 343, in at least one embodiment of the present disclosure, to offer MuniSLGs within the exchange system, the user must confirm that the issuer will comply with all applicable SEC rules and regulations, including contractual obligations arising thereunder. In such an embodiment, the system displays a pop up or other interactive graphical user interface to prompt the user with a question asking whether the user confirms that the issuer will engage in any activity through the exchange system while following applicable SEC rules and regulations, including contractual obligations arising thereunder. In addition, the system may also require that the user's verification be confirmed by a third party agent in step 343. It should be appreciated that, depending on the applicable requirements or the terms of the MuniSLGs, the specific statements and inputs may differ to conform to such requirements or terms.

In step 344, the user filters and displays the MuniSLGs within the exchange system by querying one or more value determinants or other criteria against the MuniSLGs maintained in the exchange system database. For example, the MuniSLGs may be filtered by searching for criteria such as: issuer, security type, target yield, and rating by a rating provider. By filtering the MuniSLG offerings, the user may determine the market value for MuniSLGs that the user intends to offer through the system. It should be appreciated that by storing information about the totality of MuniSLGs offerings in the exchange system and displaying such information to the user, the user is provided a market view to aid in determining whether the user's MuniSLGs may be purchased based on other market offerings.

Users interested in offering MuniSLGs for subscription may further desire to evaluate the market by finding comparable bond offerings to the user's portfolio. In step 345, the user inputs the desired future bond liabilities, bond values or other desired features of the MuniSLGs to filter from the global set of comparable bond offerings. In step 346, the user may save filtering criteria of bond offerings as a “scale” to give the user a quick reference to the market value of the user's MuniSLGs for offering based on other available MuniSLGs within the exchange system. For example, a user offering MuniSLGs at an interest rate of 2.5% may see that there are many other MuniSLGs within the system offered at a better rate. By giving this information to the user in real time, the exchange system may enable the user to adapt to other market offerings to make the user's MuniSLGs more competitive to potential purchasers.

In step 347, the system receives general security information about the MuniSLGs in which the user intends to offer through the exchange system, including, for example, maturity date, financial institution information, and others, similar to the information that may be provided in step 104 of the method 100. The user may also enter a desired amount to be offered in subscription over various fiscal years in step 348. For example, a user may allocate $4,000,000 for MuniSLG subscriptions. In step 348, the user may choose to only offer $800,000 in 2014 but increase that offering to $1,000,000 in 2015. By adjusting the offerings over a range of fiscal years, the user may obtain a broader outlook of expected revenue through the offering of MuniSLGs within the exchange system.

In step 349, a user may enter the maximum interest rates for the amounts entered to be offered as MuniSLGs and also any concessions to be attached to offerings that are sold before the maturity date. These calculations may be based on the scale provided to the user in step 344 to give the user an idea of the market offerings of MuniSLGs in order to assist in setting market-appropriate MuniSLG criteria, such as, for example, maturity date, yield, and other attributes. It should be appreciated that the user may also assign put options and accompanying put concessions when offering MuniSLGs in step 350 that would be used in the event that a buyer wanted to issue a put option against purchased MuniSLGs as described in the method 320.

After setting all of the characteristics of MuniSLGs to be offered on the exchange system, the MuniSLG offerings are posted with accompanying descriptions to all purchasers through the exchange system in step 351. In this step, the MuniSLGs become publicly tradeable through the exchange system for any purchaser. In step 352, the exchange system receives requests for subscription by various purchasers interested in the offered MuniSLGs and records all details of such subscriptions. In step 353, the exchange system updates all transactions as subscriptions are made to the offered MuniSLGs and ensures that the subscribed MuniSLGs do not exceed the user's maximum interest rate or maximum amount set for such MuniSLGs. In the event that such subscriptions do not violate the user settings, the exchange system confirms subscriptions and exchanges financial institution information to effectuate the sale in step 354. The finalization and verification of the sale may occur through the methods previously described herein.

In yet another embodiment, the exchange system may also be configured to enable a user to offset losses against gains in municipal bond investments. An investor may realize a taxable capital gain or a loss in a municipal bond investment. It is possible that a taxable gain in a municipal bond investment may exist where a municipal bond is sold at a price that is above the amortized tax basis less the amortization of any tax exempt original issue discount (if any) and the de minimis allowance for capital gains. It is also possible that taxable gains may accrue during the life of the municipal bond and be realized when the bond matures.

It is possible that a taxable loss in a municipal bond investment may occur when the municipal bond is sold at a price that is below its amortized tax basis. In some cases, a user may wish to use a taxable loss to offset any taxable gain from municipal bonds or any other assets and/or ordinary income. As used herein, a “tax swap” refers to a municipal bond tax trade wherein a municipal bond is sold to realize a loss and the proceeds of the sale are reinvested in other municipal bonds.

In some cases, a tax loss may not be recognized if the proceeds from the sale are invested in a municipal bond that is identical to the one that was sold. This phenomenon is referred to as a “wash sale.” It should be appreciated that in one embodiment, the exchange system may enable a user to avoid such wash sales by using the proceeds from the sale of certain securities to purchase other securities that comply with any requirement that the sold and purchased municipal bonds are not identical.

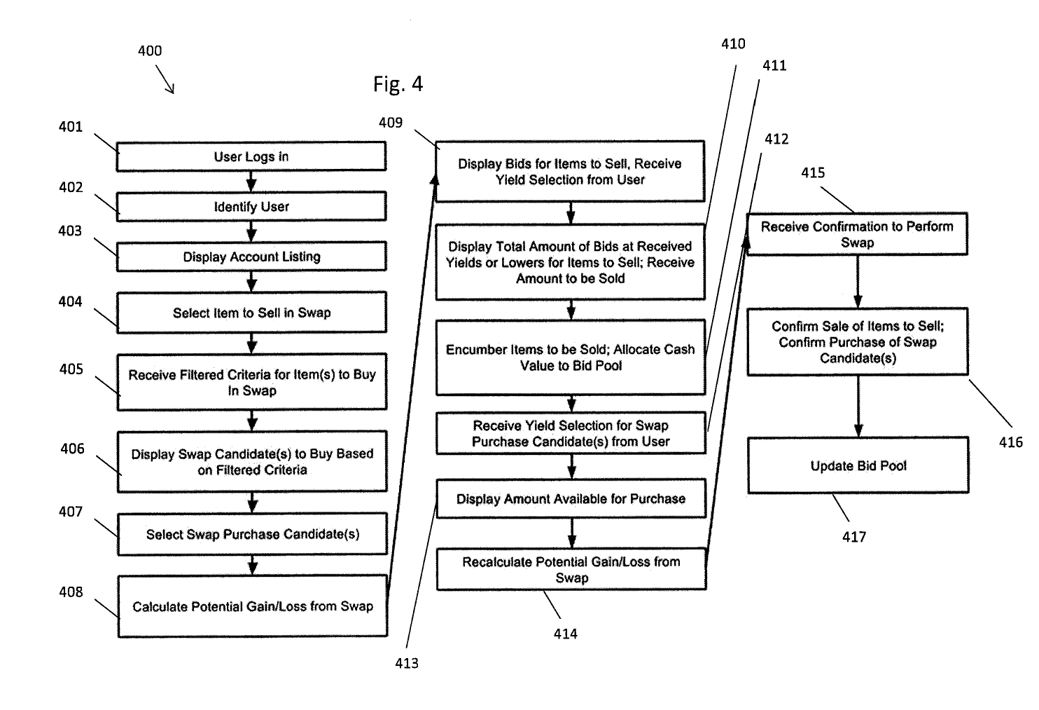

Referring now to FIG. 4, a method 400 for performing a tax swap within an exchange system is shown, that comprises the steps of: authenticating a user in step 401, identifying the user in step 402, displaying an account listing for the user in step 403, receiving a request to perform a tax swap of one or more items in step 404, receiving a filtered criteria for items to buy in the swap in step 405, presenting potential swap candidate(s) to the user based on the filtered criteria in step 406, selecting swap purchase candidate(s) in step 407, calculating the potential gain/loss from the selected swap in step 408, viewing the book of bids for the items to be sold and entering a yield for each item in step 409, displaying the total yield of bids for each item and in aggregate in step 410, ordering the amount of the item to be sold encumbered and reserving the value to the user's bid pool in step 411, inputting the yield for one or more of the selected candidates to purchase in step 412, displaying the amount of each candidate selected that may be purchased at the inputted yield in step 413, recalculating the resulting loss or gain based on the inputted yields in step 414, directing the system to execute the swap in step 415, confirming orders for the swap with any number of counterparties on the buy and sell side in step 416, and updating the bidding pool amount during execution of the swap in step 417. It should be appreciated that a tax swap combines the process of selling a municipal bond within the exchange system with the process of buying a municipal bond within the exchange system with the added requirement that the municipal bond purchased is different from the municipal bond sold in order to avoid a wash sale. Accordingly, the methods previously described herein for purchasing a municipal bond and selling a municipal bond may be used, but it should be appreciated that any tax strategy requires that the user consult his or her own tax advisor and that an exchange system does not provide tax advice nor does it confirm the appropriateness of a transaction for tax purposes.

In step 401, the exchange system authenticates a user. As discussed previously, in step 401, a user attempting to access the exchange system may be required to provide authentication credentials to verify the user's identity. For example, the user may input a username and password, client-side certificate, one-time password and PIN, or other credentials that uniquely identify a specific user. Third party authentication tools may also be used, such as OAuth and OpenID. In a preferred embodiment, the authentication credentials are inputted from a client device to the central server of the exchange system over a computer network, and the authentication information is stored in the system database. In a further embodiment, when the exchange system is accessed through the Internet using a web browser or similar application, the system may inject a cookie within the web browser to reference the user's session with the system.

In yet another embodiment, the system may also verify that the authenticated user is authorized to perform activities within the exchange system.

In step 402, the exchange system identifies the user based on the credentials provided in step 401. By identifying the user, the exchange system determines the user's associated personal information, bond information, financial institution account information, any configured agents, and the like. Further, step 402 identifies the authorization that the user is provided thereby indicating what activities the user may perform within the exchange system, such as, for example, buying and selling municipal bonds.

In step 403, the user identifies and inputs information about one or more municipal bonds into the exchange system and views his or her account listing—e.g., as described for method 100. As discussed previously, the market value and gain/loss information for each municipal bond inputted by a user is maintained in the exchange system database. Accordingly, the step 403 may also include retrieving or deriving gain/loss information for the municipal bonds within the exchange system.

In step 404, the user selects one or more bonds and inputs a request to perform a tax swap. In one embodiment, the exchange system may monitor the user's bond portfolio in the exchange system, identify a potential loss in market value of one or more identified municipal bonds associated with the user's portfolio, display the identified bonds and alert the user to the existence of a possible tax swap. For example, the exchange system may alert the user by highlighting the loss information in a separate color when the municipal bond is displayed to the user, by issuing a pop up window or other alert on a user's web browser, and/or by sending an alert to a user designated SMS and/or email address. In a further embodiment, the alert may also be configured to allow the user to input a request to perform a tax swap with the identified bond.

In step 405, the central server of the exchange system receives the request to perform a tax swap and identifies and displays all potential investment bonds within the exchange system. In a further embodiment, the user may filter the set of potential investment bonds by selecting the change in feature to avoid a wash sale. For example, the user may input a change in the rating of the bond, or a change in the maturity year of the bond being sold. The exchange system queries the selected change in feature against all potential investment bonds within the exchange system.

In step 406, the exchange system displays potential candidates for the user to perform the swap based on the filtering criteria in step 405. For example, if the user entered a change in the rating of the bond as filtering criteria, the exchange system will pull all available municipal bonds that match the change in rating criteria as potential swap candidates.

In step 407, the user selects one or more municipal bonds from the filtered list to perform a swap. The system then calculates the potential gain/loss from the swap to assist the user in determining whether the selected bond avoids any applicable wash sale rules and invests the user's realized loss from the sale of the bond selected for swap appropriately. In step 409, the system evaluates other bids within the system to purchase the municipal bond(s) selected for swap and determines whether the user's bid will be matched quickly to perform the swap. In step 410, the system displays such bids at received yields or lower and receives the amount to be sold in the swap.

In step 411, the system starts to perform the swap by encumbering the items to be sold and allocating the cash value as virtual funds to the user's bidding pool. In step 412, the user inputs a yield selection for the swap candidates to the system. The system then calculates the amount available for purchase based on the inputted yield and displays it to the user in step 413. In step 414, the system recalculates the potential gain/loss from the swap (similar to step 408) to verify that the market has not changed in a way to materially alter the swap. Then, the user confirms the swap to be performed in the system in step 415.

In step 416, the system starts to perform the swap. It should be appreciated that the system will first confirm sale of the municipal bonds for swap before making any purchase to avoid the user purchasing municipal bonds without realized cash value in his or her account. Thus, the system will confirm the sale of the municipal bond for swap and then proceed to confirm the purchase of the selected candidate(s) for swapping in step 416. At the conclusion of the swap, both the sale and purchase will be confirmed through the methods described herein in clearing houses and seller and buyer financial institutions. In step 417, the system will update and display the user's bid pool which will show that the swap has been performed.

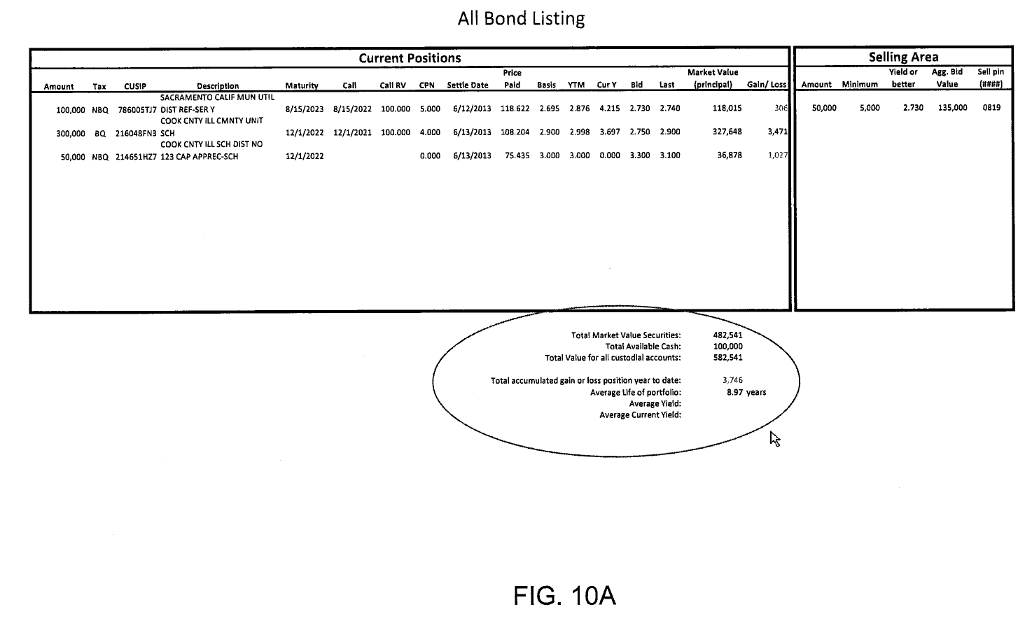

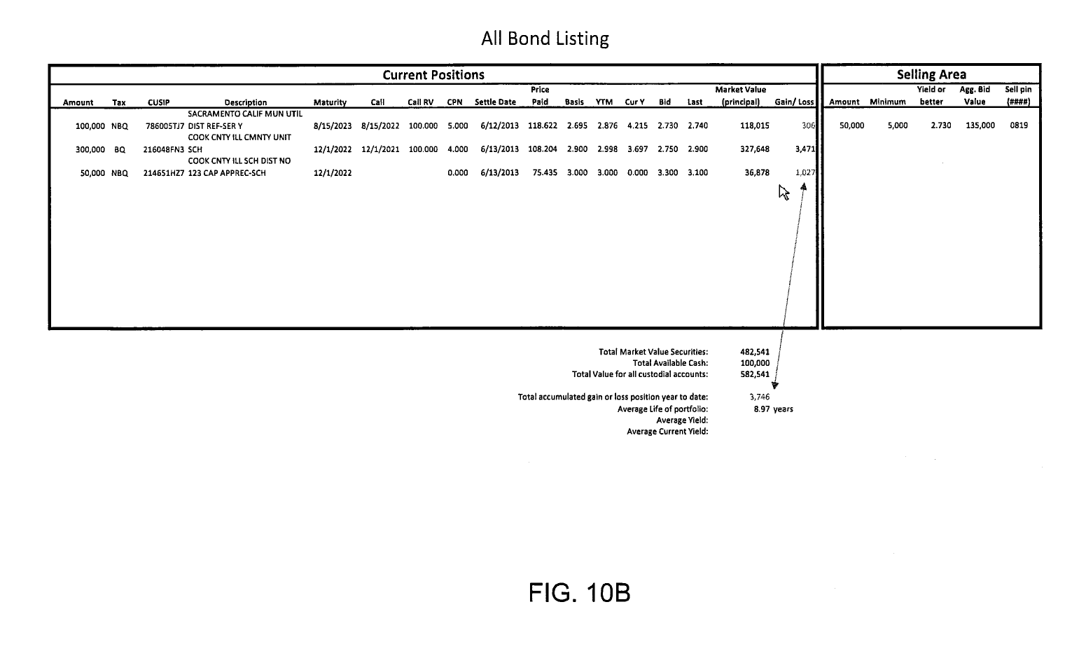

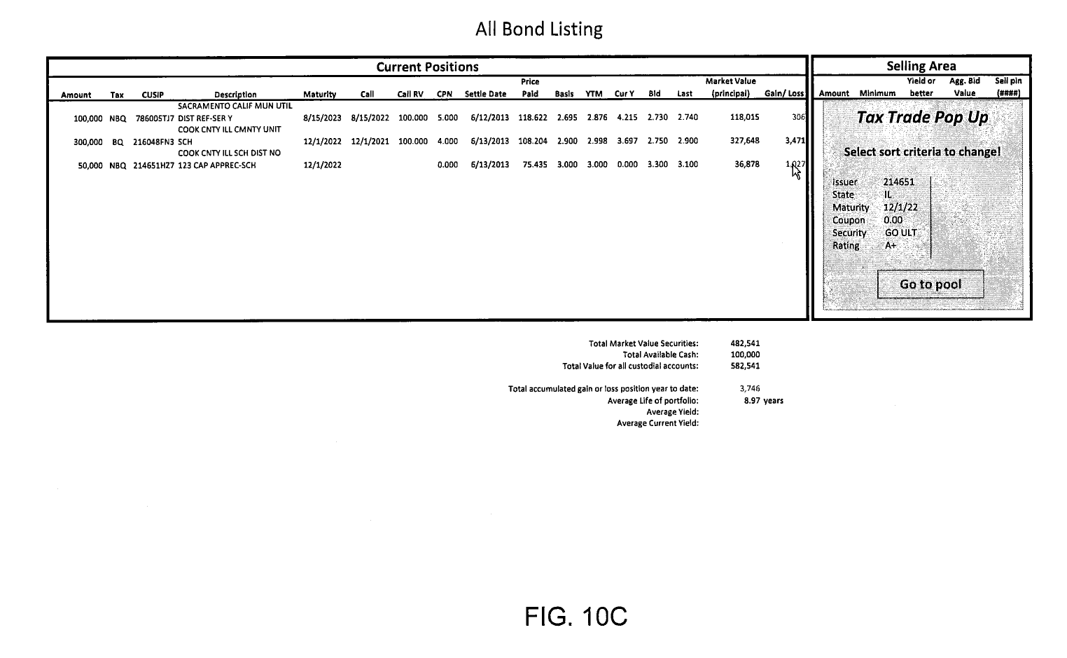

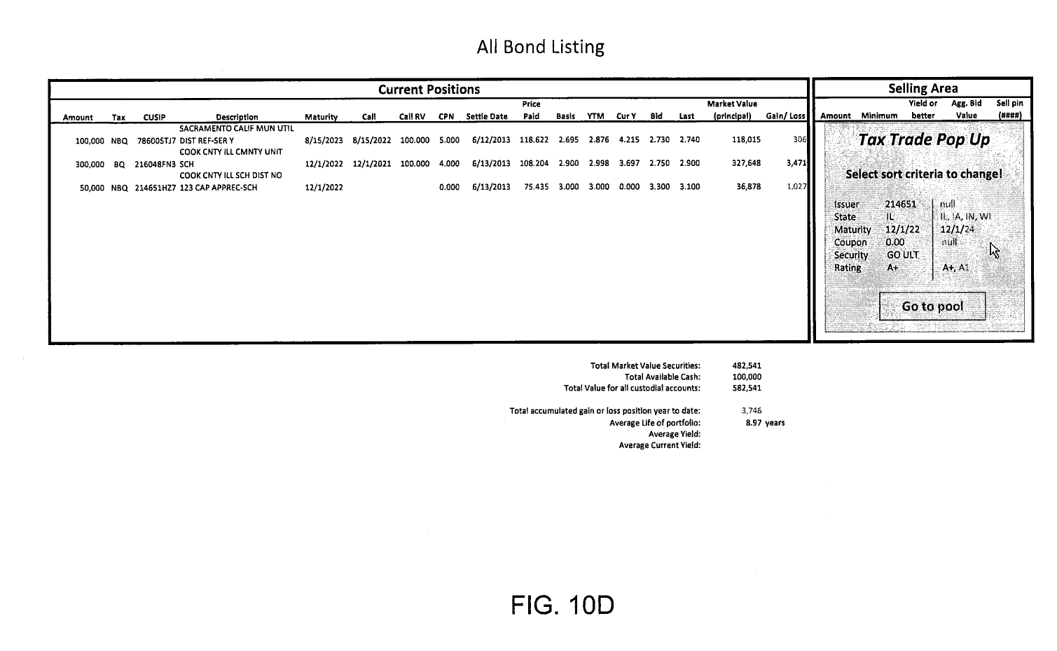

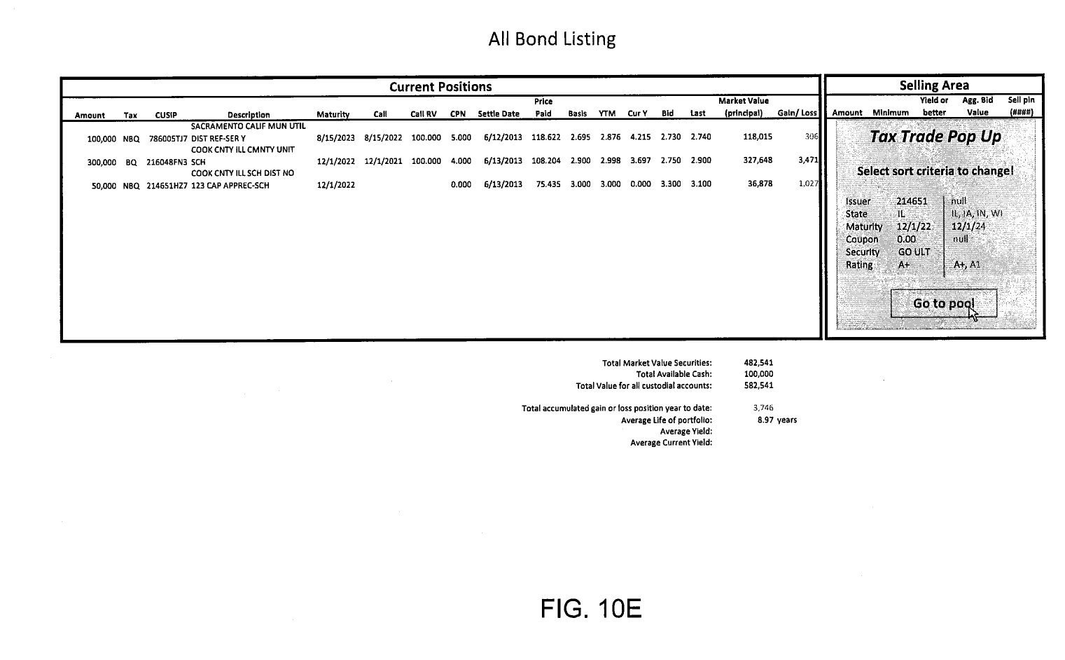

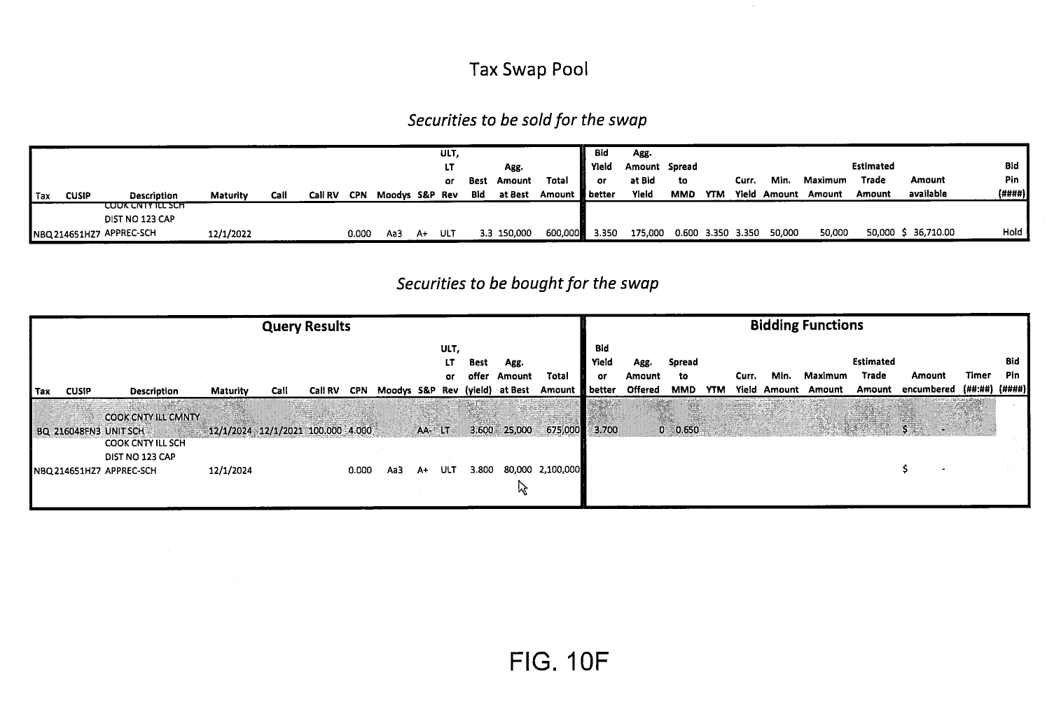

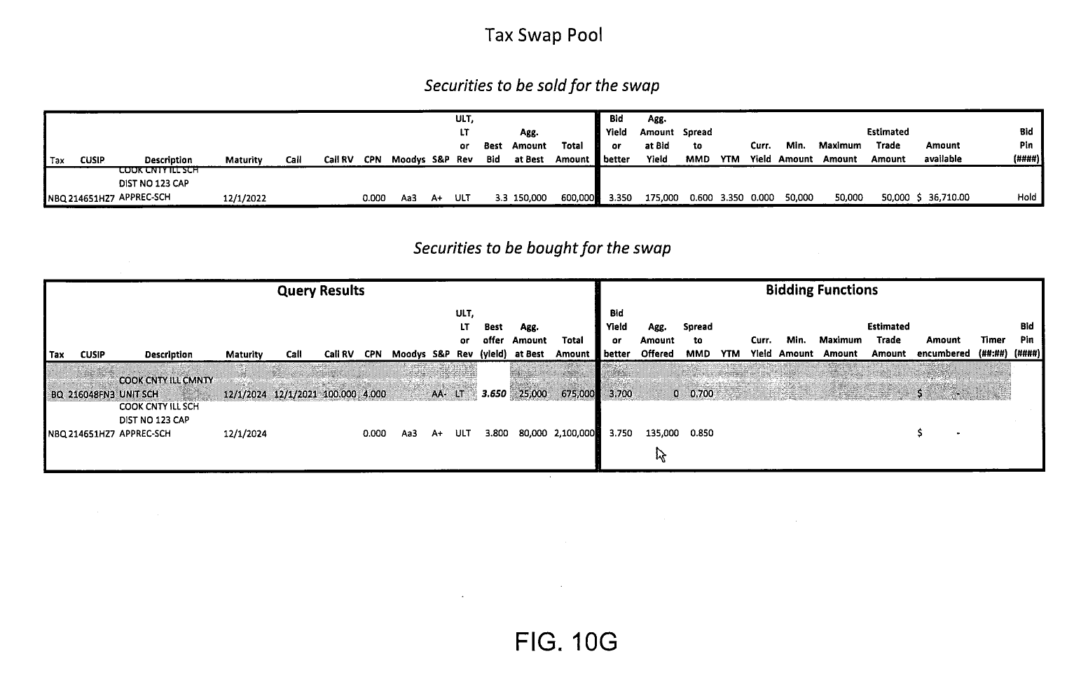

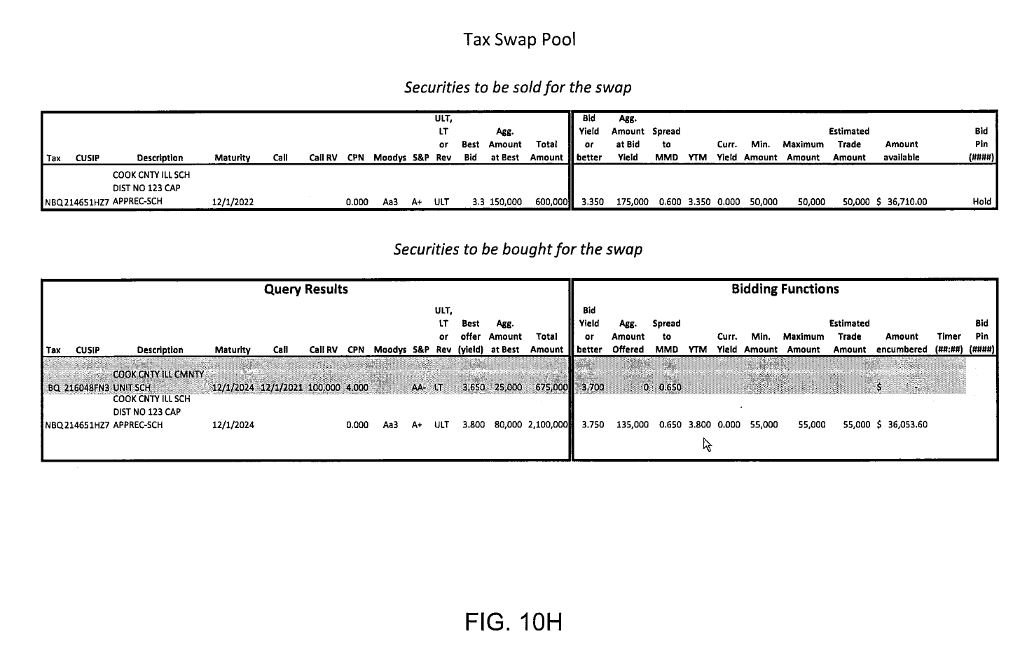

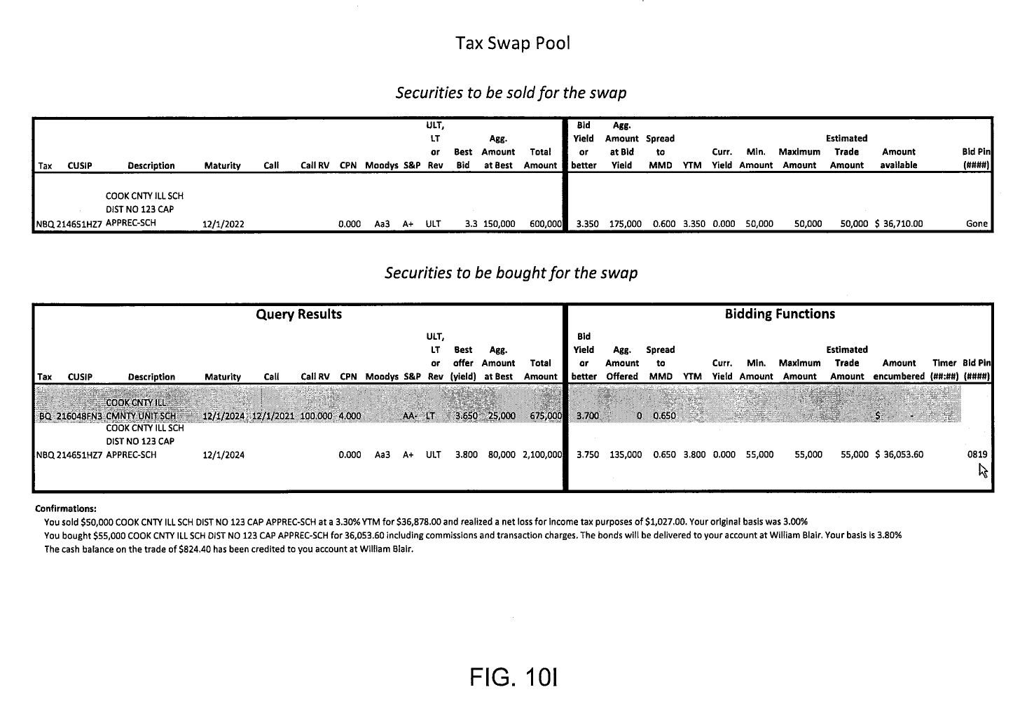

Examples of graphical user interfaces for execution of the method 400 in the exchange system are shown in FIGS. 10A-10I.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. An exchange system for electronically trading municipal bonds, comprising:
a database coupled with a central server configured to execute software processes wherein the database stores municipal bond information and user information and the database and central server allow a user to input the municipal bond information and the user information, view and sort available municipal bond information of market participants, and execute trades matched through the exchange system;
one or more client devices connected to the central server through a network, wherein the client devices are configured to display information from the database and input or modify information within the database;
one or more financial institution servers, wherein the financial institution servers maintain and provide access to information regarding municipal bonds held in custody at financial institutions; and
at least one clearing house server that communicates with the financial institution servers and the central server to verify and effectuate the purchase and sale of municipal bonds.

2. The exchange system of claim 1, wherein the central server comprises a set of disparate servers providing software as a server through a website.

3. The exchange system of claim 1, wherein the financial institution servers receive and process queries from the central server relating to transactions on the exchange system.

4. The exchange system of claim 3, wherein the financial institution servers maintain and provide access to information regarding securities and funds.

5. The exchange system of claim 1, wherein the database contains information regarding municipal bonds that are held by a particular financial institution and a financial institution server associated with that financial institution effectuates transactions relating to those bonds or funds through the central server.

6. A computer implemented method comprising:
receiving, by a processor, user information from a user including authentication credentials for use with an exchange system;
assigning, by the processor, a unique identifier to the user;
receiving, by the processor, information identifying a financial institution for withdrawing and depositing the user's funds; and
receiving, by the processor, information identifying securities held by the user and a custodial institution that holds those securities.

7. The computer implemented method of claim 6, further comprising:
communicating, by the processor, with the financial and custodial institutions to verify the information received.

8. The computer implemented method of claim 7, further comprising:
receiving, by the processor, agent information to allow an agent to access the exchange system and act on the user's behalf.

9. The computer implemented method of claim 7, further comprising:
assigning, by the processor, a unique identification code for each of the securities held by the user.

10. The computer implemented method of claim 7, further comprising:
displaying, by the processor, a listing of the user's portfolio of municipal bonds within the system

11. An exchange system for electronically trading municipal bonds, comprising:
a central server which stores securities and funds information and user information and executes software processes which allow a user to input municipal bond information and user information and to view and sort available municipal bond information of market participants;
a buyer device and a seller device coupled to the central server through a network;
a buyer's financial institution server;
a seller's financial institution server; and
wherein when a transaction is entered between buyer device and seller device, the central server communicates with the buyer's financial institution server and seller's financial institution server to effectuate the transfer of securities and/or funds.

12. The exchange system of claim 11, further comprising:
at least one clearing house server that communicates with the financial institution servers and the central server to verify the transaction prior to exchanging funds or securities.

13. The exchange system of claim 11, wherein the central server comprises a set of disparate servers providing software as a server through a website.

14. The exchange system of claim 11, wherein the financial institution servers maintain and provide access to information regarding securities and funds.

15. The exchange system of claim 11, wherein the financial institution servers receive and processes queries from the central server relating to transactions on the exchange system.

16. The exchange system of claim 11, wherein the central server contains information regarding municipal bonds or funds that are held by a particular financial institution and a financial institution server associated with that financial institution effectuates transactions relating to those bonds or funds through the central server.

17. The exchange system of claim 11, wherein the central server matches bonds for sale with bonds for purchase having specified similarities and differences in characteristics.

18. The exchange system of claim 11, wherein, the seller device represents an issuer of a new issue of municipal securities and the central server communicates to the seller device municipal bond information previously inputted by the seller device, as adjusted by the central server, pursuant to parameters inputted by the seller device, to reflect the terms of an executed transaction in the new issue of municipal securities.
